(19) United States
(12) Patent Application Publication
(10) Pub. No.: US 2008/0071878 A1
(43) Pub. Date: Mar. 20, 2008

(54) Method and system for strong-leader election in a distributed computer system

(76) Inventor: James M. Reuter, Colorado Springs, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/523,430

(22) Filed: Sep. 18, 2006

(51) Int. Cl. G06F 15/16; G06F 15/173

(52) U.S. Cl. 709/208; 709/224; 709/223

(57) ABSTRACT

Embodiments of the present invention provide methods and systems for strong-leader election in a distributed computer system. In certain embodiments of the present invention, nodes employ a distributed consensus service, such as Paxos, to seek election of leader at or near the expiration of each of a set of successive lease periods. A current leader seeks re-election prior to expiration of the current lease, thus favoring continued re-election of the current leader until and unless the current leader fails or surrenders the leadership role.

### TECHNICAL FIELD OF THE INVENTION

The present invention is related to distributed computing and, in particular, to a method and system for efficiently and robustly allocating a leadership role to one of a group of nodes within a distributed computer system.

### BACKGROUND OF THE INVENTION

In the early days of computing, computer systems were stand-alone devices accessed by computer users via input/output (“I/O”) peripheral components, including control-panel toggle switches, Hollerith-card readers, line printers, and eventually cathode-ray-tube (“CRT”) 24-line terminals and keyboards. When a user wished to carry out a computational task on more than one computer system, the user would manually transfer data between the computer systems via Hollerith cards, magnetic tape, and, later, removable magnetic-disk packs.

With the advent of multi-tasking operating systems, computer scientists discovered and addressed the need for synchronizing access by multiple, concurrently executing tasks to individual resources, including peripheral devices, memory, and other resources, and developed tools for synchronizing and coordinating concurrent computation of decomposable problems by independent, concurrently executing processes. With the advent of computer networking, formerly independent computer systems were able to be electronically interconnected, allowing computer systems to be linked together to form distributed computer systems. Although initial distributed computer systems were relatively loosely coupled, far more complex, tightly coupled distributed computer systems based on distributed operating systems and efficient, distributed computation models, have since been developed.

There are many different models for, and types of, distributed computing. In some models, relatively independent, asynchronous, peer computational entities execute relatively autonomously on one or more distributed computer systems, with sufficient coordination to produce reliable, deterministic solutions to computational problems and deterministic behavior with respect to external inputs. In other distributed systems, tightly controlled computational entities execute according to pre-determined schedules on distributed computer systems, closely synchronized by various protocols and computational tools. In many fault-tolerant and highly available distributed computer systems, computational tasks are distributed among individual nodes, or computers, of the distributed computer system in order to fairly distribute the computational load across the nodes. In the event of failure of one or more nodes, surviving nodes can assume, or be assigned, tasks originally distributed to failed nodes so that the overall distributed computational system is robust and resilient with respect to individual node failure. However, even in distributed systems of relatively independent peer nodes, it is frequently the case that, for certain tasks, a single node needs to be chosen to be responsible for the task, rather than simply allowing any of the peer nodes to contend for the task, or subtasks that together compose the task. In other words, a single node is assigned to be, or elected to be, the leader with respect one or more tasks that require investing responsibility for the one or more tasks in a single node. Tasks for which leaders need to be assigned are generally tasks that are not efficiently decomposed, iterative tasks with high, initial-iteration computational overheads, and tasks that require assembling complex sets of privileges and control over resources. Examples of such tasks include coordinator-type tasks in which a single node needs to be responsible for distributed state changes related to distributed-system management, distributed-system-updating tasks, including installation of software or software updates on nodes within the distributed system, system-state-reporting tasks, in which a single node needs be responsible for accessing and reporting the distributed state of a distributed computer system, and, in certain systems, scheduling, distribution, and control tasks for the distributed system.

A leadership-role allocation can be hard wired, or statically assigned at distributed-system initialization, for all, a subset of, or individual tasks needing a leader. However, relatively static leader assignment may lead to time-consuming and difficult leader-reassignment problems when a leader node fails or becomes incapable of carrying out those tasks required of the leader node. Alternatively, all nodes can constantly contend for leader roles for tasks requiring a leader on an on-demand basis, but constant leader-role contention may be inefficient and may even lead to thrashing. Therefore, designers, manufacturers, and users of distributed systems recognize the need for efficient, leader-role allocation within distributed systems that is robust and resilient with respect to node, communications-link, and component failures within a distributed system, and that maintains leadership allocations over extended periods of time or over extended computation.

### SUMMARY OF THE INVENTION

Embodiments of the present invention provide methods and systems for strong-leader election in a distributed computer system. In certain embodiments of the present invention, nodes employ a distributed consensus service, such as Paxos, to seek election of leader at or near the expiration of each of a set of successive lease periods. A current leader seeks re-election prior to expiration of the current lease, thus favoring continued re-election of the current leader until and unless the current leader fails or surrenders the leadership role.

### BRIEF DESCRIPTION OF THE DRAWINGS

FIGS. 1A-G illustrate the Paxos distributed consensus service.

FIGS. 2-8 illustrate the basic operation of a distributed storage register.

FIG. 9 shows the components used by a process or processing entity Pᵢ that implements, along with a number of other processes and/or processing entities, P_{j≠i}, a distributed storage register.

FIG. 10 illustrates determination of the current value of a distributed storage register by means of a quorum.

FIG. 11 shows pseudocode implementations for the routine handlers and operational routines shown diagrammatically in FIG. 9.

FIG. 12 illustrates a disk-Paxos or active-disk-Paxos distributed computer system.

FIG. 13 illustrates an exemplary distributed computer system in which strong-leader election may be practiced according to methods and systems of the present invention.

FIG. 14 is a control-flow diagram illustrating general node operation and strong-leader election, according to embodiments of the present invention.

FIG. 15 is a control-flow diagram illustrating the routine “elect self,” which represents an embodiment of the present invention.

FIGS. 16A-G illustrate the strong-leader election method of the present invention.

FIG. 17 illustrates, in similar fashion to FIG. 13, an alternative distributed computer system in which strong-leader election may be practiced according to methods and systems of the present invention.

FIGS. 18A-D illustrate operation of delay-timer-based alternative embodiments of the present invention.

FIG. 19 is a control-flow diagram illustrating an alternative embodiment of the present invention.

FIGS. 20A-C illustrate operation of the alternative embodiment of the present invention.

### DETAILED DESCRIPTION OF THE INVENTION

The present invention is related to distributed computing. Certain embodiments of the present invention rely on previously developed techniques for distributing state information among the nodes of a distributed system. One such technique is the Paxos distributed consensus service. The functionality provided by Paxos is described, below, in a first subsection. Another, related technique provides a distributed storage register to multiple nodes in a distributed system, described in a second subsection, below. The distributed storage register is a particularly easily described distributed consensus service, and is included primarily to illustrate how distributed consensus services are implemented, in general. Using the Paxos distributed consensus service, related disk-Paxos services, described below in a third subsection, or an enhanced distributed storage register, a robust and efficient leader-election method and system can be devised according to embodiments of the present invention. Embodiments of the present invention are described, below, in a fourth subsection.

### Paxos Distributed Computing Model

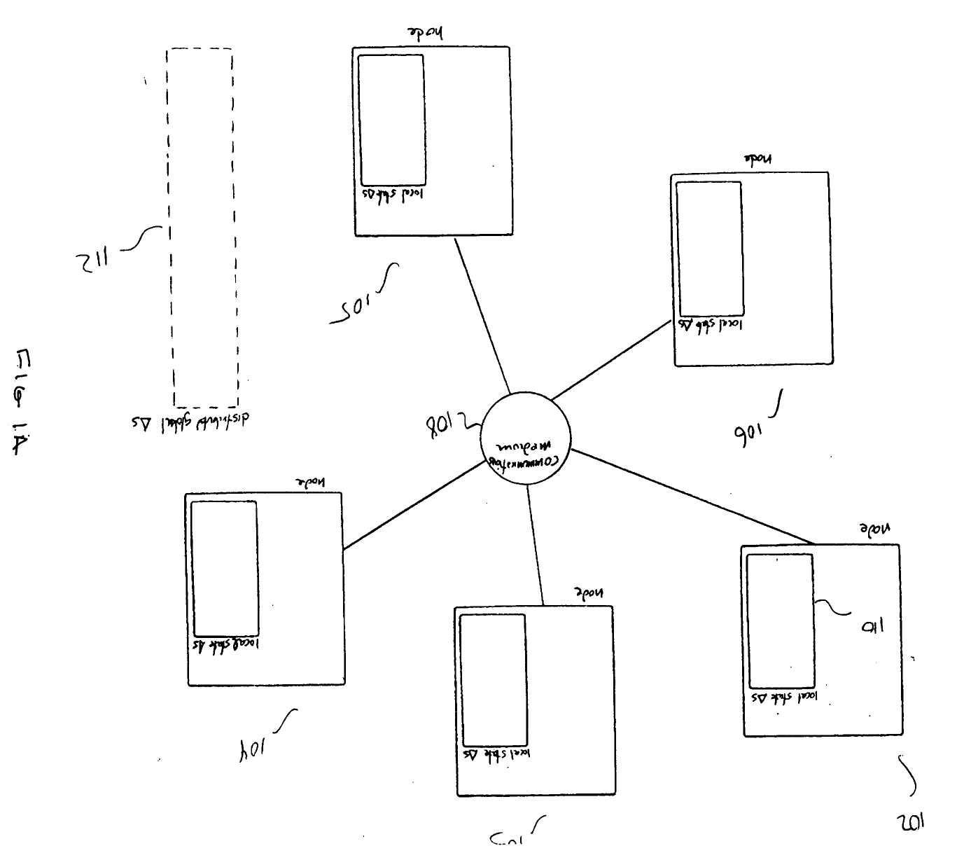

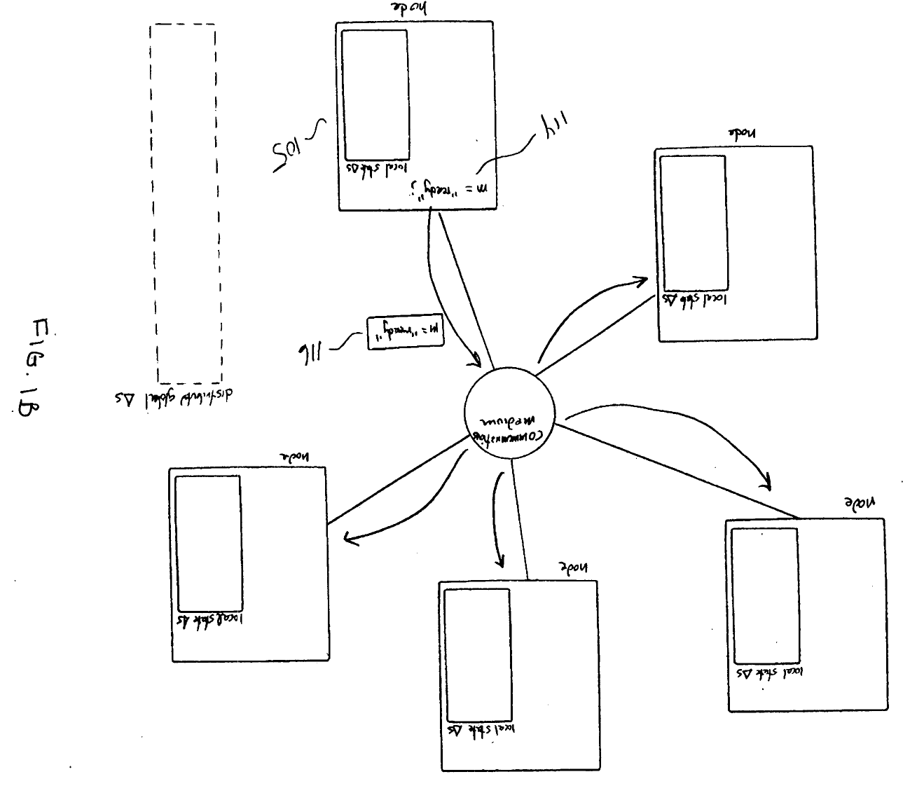

FIGS. 1A-G illustrate the Paxos distributed consensus service. FIGS. 1A-G employ the same illustration conventions, next described with reference to FIG. 1A. In FIG. 1A, five nodes 102-106 are interconnected by a communications medium 108. Each node can send messages to, and receive messages from, each of the remaining nodes. Each node includes an ordered, sequential list of state changes, such as local state change list 110 within node 102. Together, the nodes constitute a distributed computer system that manages a global, master, ordered and sequential list of state changes 112. The global list of state changes 112 is shown as a dashed-line rectangle, to indicate that the distributed system may not contain a single, full copy of the global list of state changes, but may instead maintain the global list of state changes in various pieces distributed across the nodes of the distributed computer system.

Any node can request a state change. For example, as shown in FIG. 1B, node 105 has formulated the state change request: m=“ready” 114. This state change is directed to setting the contents of variable m to the string “ready.” Node 105 asserts the state-change request by sending a state-change request message 116 to all active nodes in the distributed system. Either of two outcomes is possible. In one outcome, the state-change request is successful, and all or a portion of the active nodes in the distributed system update their local state change lists 118-122 to indicate the state change. The global distributed state-change list 112 is always updated as a product of committing a state-change request. In a second outcome, the state-change request is denied, or is unsuccessful, and no local state-change list is updated, and, of course, the global distributed state-change list 112 is also not updated.

At any point in time, certain of the nodes may become inactive, due to node failure, communications medium failure, or other failures within the distributed computer system. For example, as shown in FIG. 1D by “X” symbols 124-125, the communications links to nodes 103 and 105 may fail, leaving only nodes 102, 104, and 105 active within the distributed computer system. Following failure of nodes 103 and 105, an active node may wish to request a subsequent state change. In FIG. 1D, node 102 has formulated the state change request: n=“stop” 126. Node 102 requests this state change by sending a state-change request message 128 to the active nodes 104 and 105 within a distributed computer system. When there are sufficient active nodes to constitute a quorum of nodes, where a quorum is, in many situations, at least a majority of the nodes in a distributed system, a state-change request may succeed. In the case shown in FIG. 1D, the state-change request made by node 102 succeeds, resulting in updates to the local state-change lists of the active nodes 129-131, as shown in FIG. 1E. Inactive nodes 103 and 105 do not reflect the most recently successful state-change request, since they are not in communication with the active nodes. The distributed global state-change list 112 necessarily reflects the most recent state change. Should a formerly failed, or inactive, node be rehabilitated, and rejoin the distributed computer system, as in the case of node 103 in FIG. 1F, the reactivated node can update its local state-change list by issuing a no-operation (“NOP”) request 132 to the distributed computer system. A by-product of issuing any request, including a state-change request, is that the local state-change list of the node issuing the request is brought up to date with respect to the global, master state-change list 112 prior to the request being issued. This guarantees that there is a global ordering of issued and executed requests, memorialized in the distributed global state-change list 112. Following execution of the NOP request, reactivated node 103 has an updated local state-change list, shown in FIG. 1G.

When a sufficient number of nodes have failed that a quorum of nodes is not active, no state-change request can succeed. The Paxos distributed consensus services employs a communications protocol to achieve a distributed global state-change list and to manage state-change requests and state-change-request execution. Two or more nodes may simultaneously issue state-change requests, or issue state-change requests in a sufficiently short period of time that the state-change requests cannot be distinguished from one another in time-precedence order. In such cases, the Paxos protocol chooses one of the contending state-change requests for execution, and fails the remaining, simultaneous state-change requests. Depending on the particular Paxos implementation, a local state-change list may not be updated as a result of commitment of a next state-change request, if the containing node is not a member of the quorum for commitment of the next state-change request. However, when the node itself next makes a state=change request or issues a NOP request, the node's local state-change list is guaranteed to include all previous, committed state-change requests.

In summary, the Paxos distributed consensus service is a protocol that provides for a global ordering of committed state-change requests requested by individual nodes of a distributed computer system. Each node has a local state-change list that the node can access at any time, locally, to review all committed requests up through the latest committed request within the local state-change list, or a pruned subset of such all committed requests. When a node remains active, its local state-change list generally accurately reflects a global, distributed, master state-change list maintained via the Paxos protocol within the distributed computer system, with a possible lag in updates due to not being involved in recent quorums. If a node loses communications contact with the remaining nodes of the distributed computer system, the node may still use the local state-change list for stand-alone computation. When node rejoins the distributed computer system, the node can update its local state-change list by issuing a state-change request, including a NOP request. Thus, a node learns of any committed requests not yet known to the node no later than the point in time at which the node makes a next state-change request.

In the next subsection, a distributed storage register implementation is discussed. A distributed storage register is less complex than a global state-change list, and may be used as the basis for more complex, globally consistent data sets. The distributed storage register implementation is illustrative of the types of techniques used to implement quorum-based distributed-computing service, such as Paxos.

### Storage Register Model

As discussed in the previous section, a distributed storage register is a relatively simple distributed-computing entity that can be implemented by quorum-based techniques similar to those employed in the Paxos protocol. A distributed storage register is a globally shared data entity that is distributed across the nodes of a distributed computer system and that can be updated by any of the nodes according to a Paxos-like protocol. Strong-leader election according to the present invention may be implemented above a distributed storage register, with certain enhancements mentioned in a later subsection. The distributed storage register is described, in this subsection, as an exemplary, and easily understood, distributed consensus service.

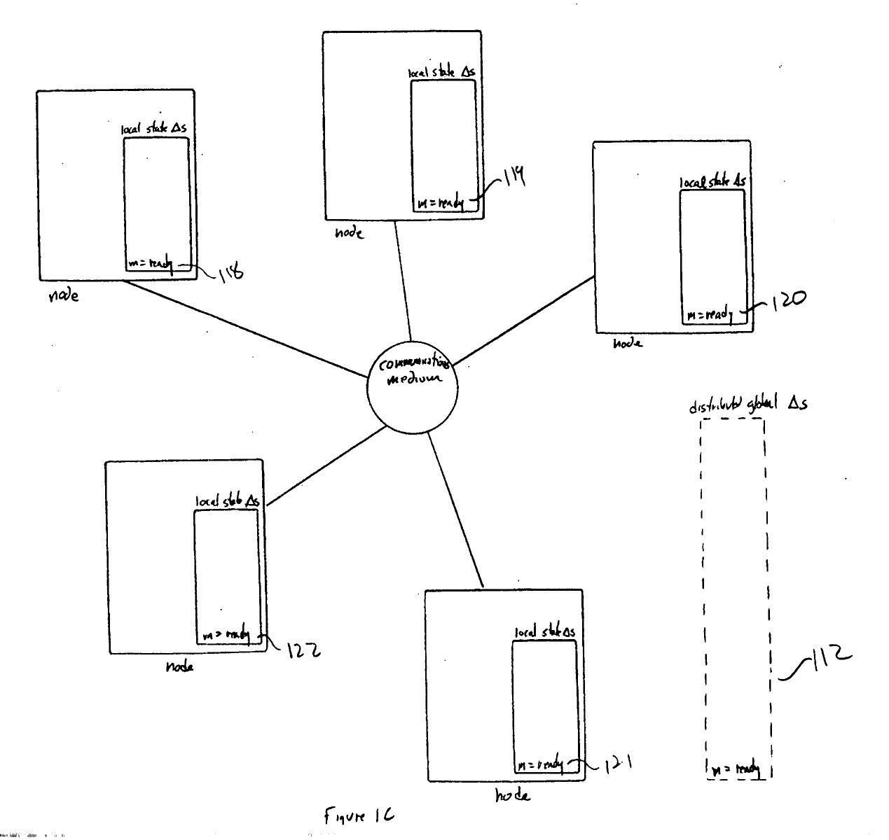

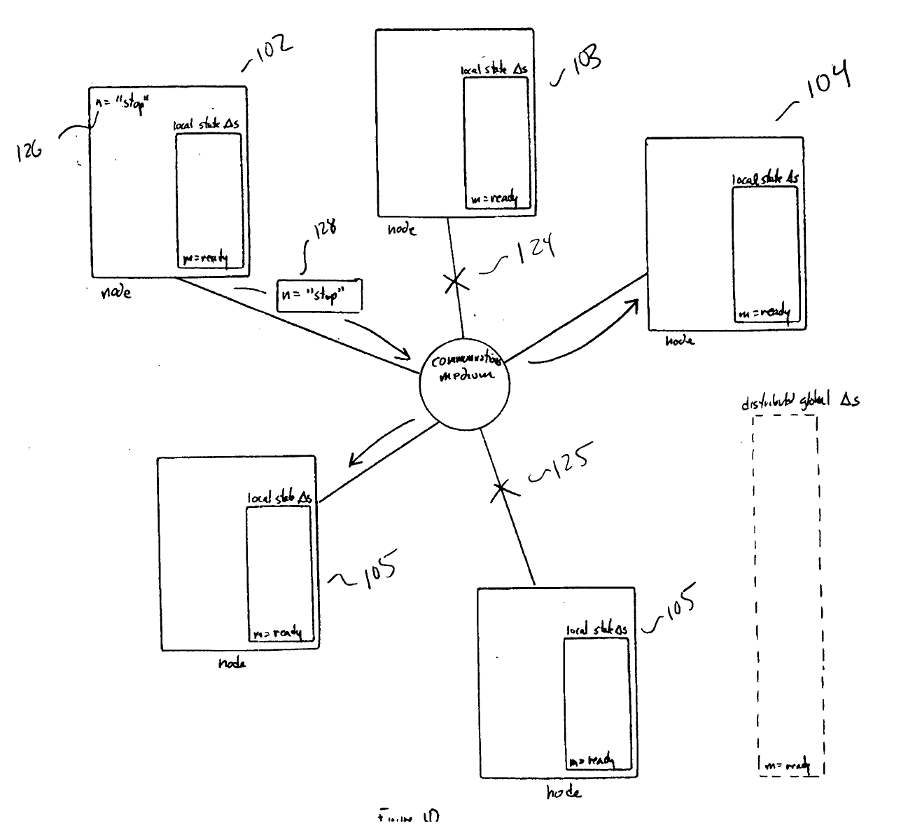

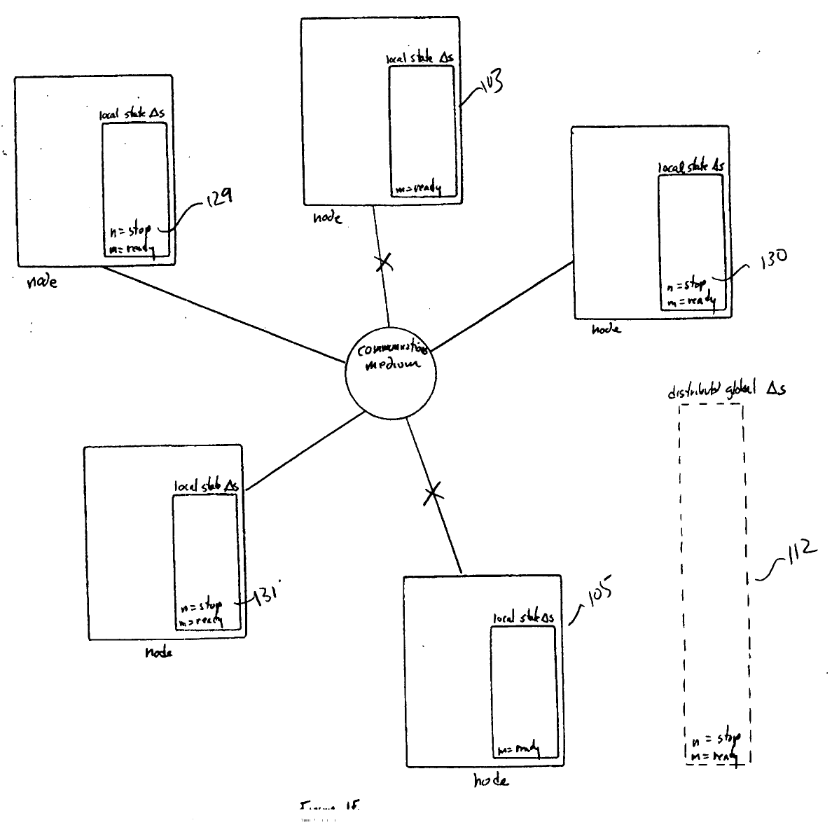

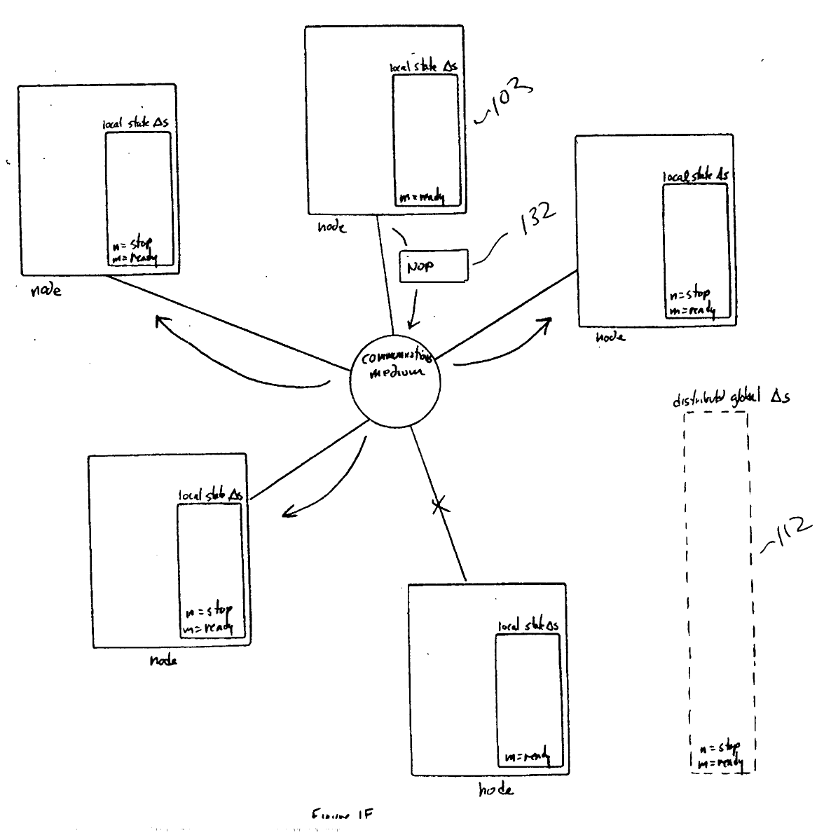

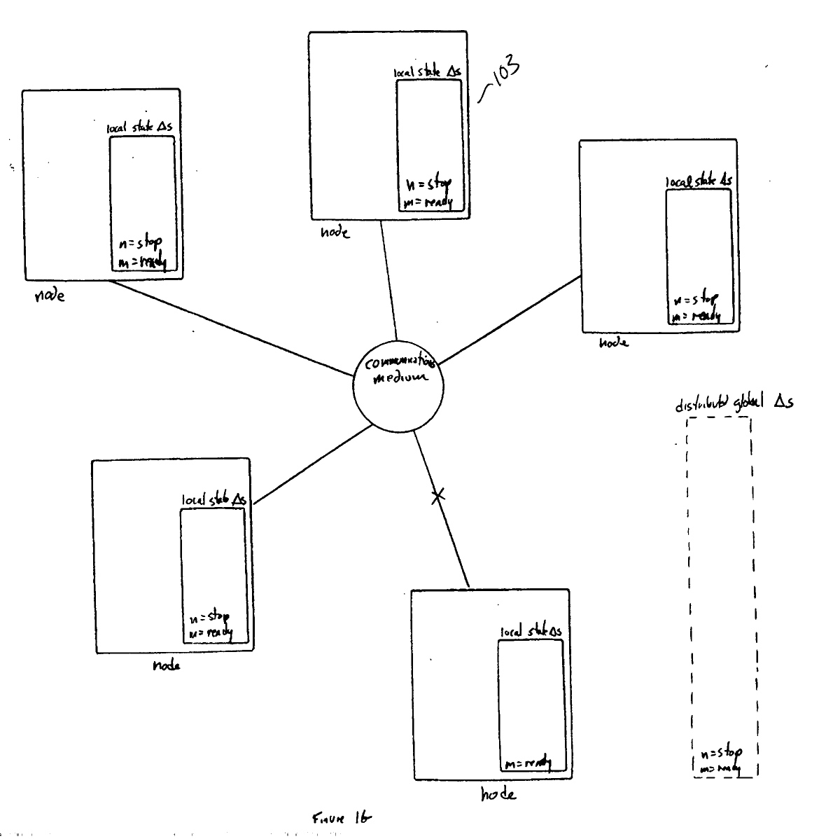

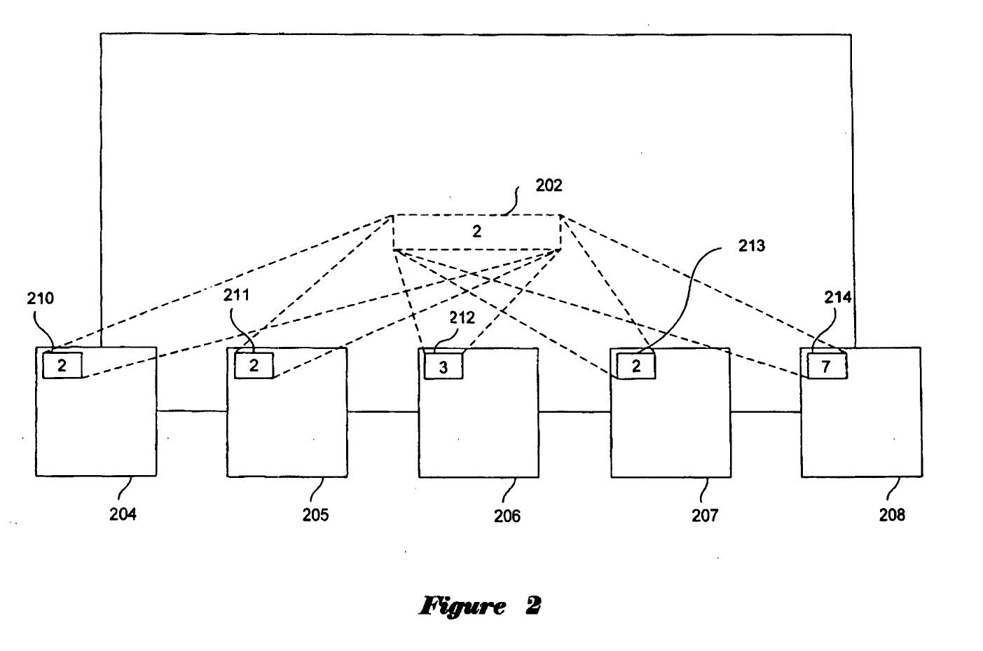

FIGS. 2-8 illustrate the basic operation of a distributed storage register. As shown in FIG. 2, the distributed storage register 202 is preferably an abstract, or virtual, register, rather than a physical register implemented in the hardware of one particular electronic device. Each process running on a processor or computer system 204-208 employs a small number of values stored in dynamic memory, and optionally backed up in non-volatile memory, along with a small number of distributed-storage-register-related routines, to collectively implement the distributed storage register 202. At the very least, one set of stored values and routines is associated with each processing entity that accesses the distributed storage register. In some implementations, each process running on a physical processor or multi-processor system may manage its own stored values and routines and, in other implementations, processes running on a particular processor or multi-processor system may share the stored values and routines, providing that the sharing is locally coordinated to prevent concurrent access problems by multiple processes running on the processor.

In FIG. 2, each computer system maintains a local value 210-214 for the distributed storage register. In general, the local values stored by the different computer systems are normally identical, and equal to the value of the distributed storage register 202. However, occasionally the local values may not all be identical, as in the example shown in FIG. 2, in which case, if a majority of the computer systems currently maintain a single locally stored value, then the value of the distributed storage register is the majority-held value.

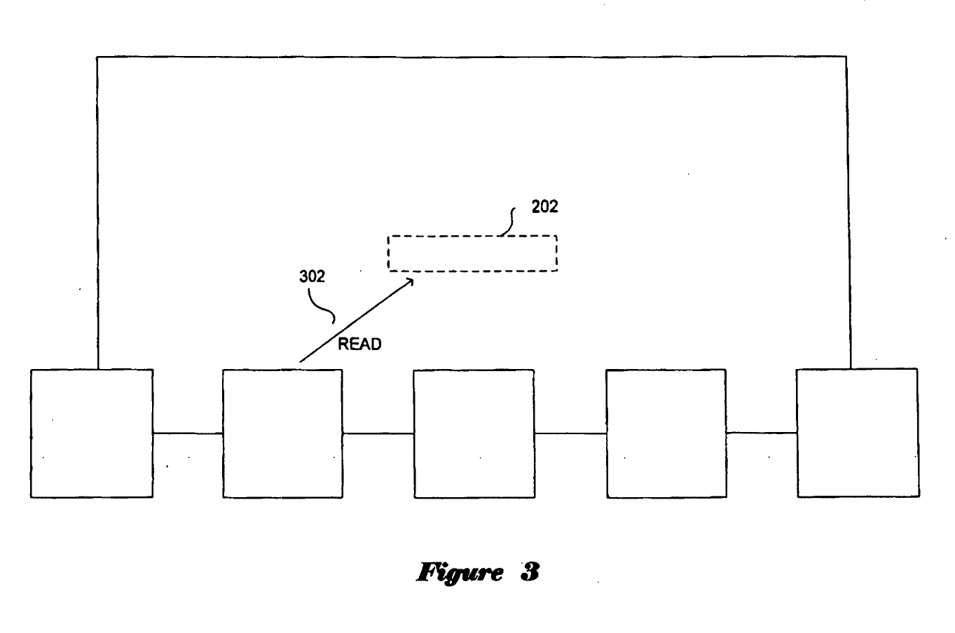

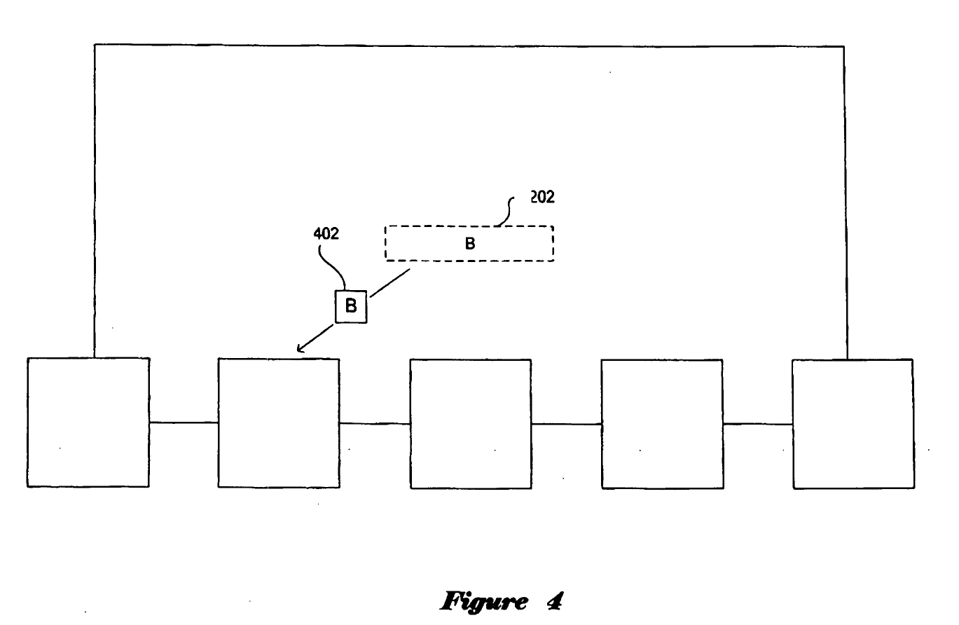

A distributed storage register provides two fundamental high-level functions to a number of intercommunicating processes that collectively implement the distributed storage register. As shown in FIG. 3, a process can direct a READ request 302 to the distributed storage register 202. If the distributed storage register currently holds a valid value, as shown in FIG. 4 by the value “B” within the distributed storage register 202, the current, valid value is returned 402 to the requesting process. However, as shown in FIG. 5, if the distributed storage register 202 does not currently contain a valid value, then the value NIL 502 is returned to the requesting process. The value NIL is a value that cannot be a valid value stored within the distributed storage register.

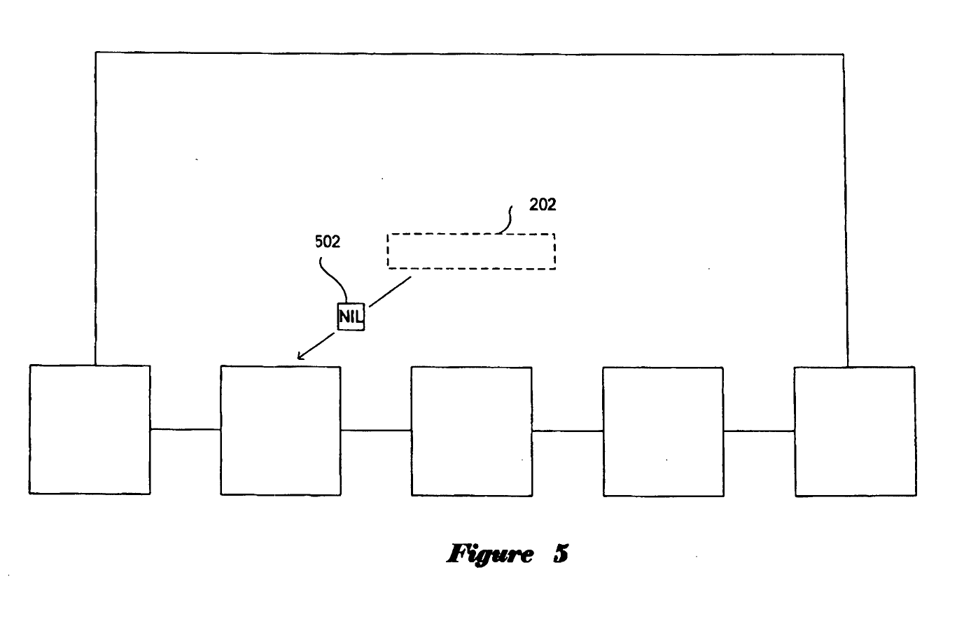

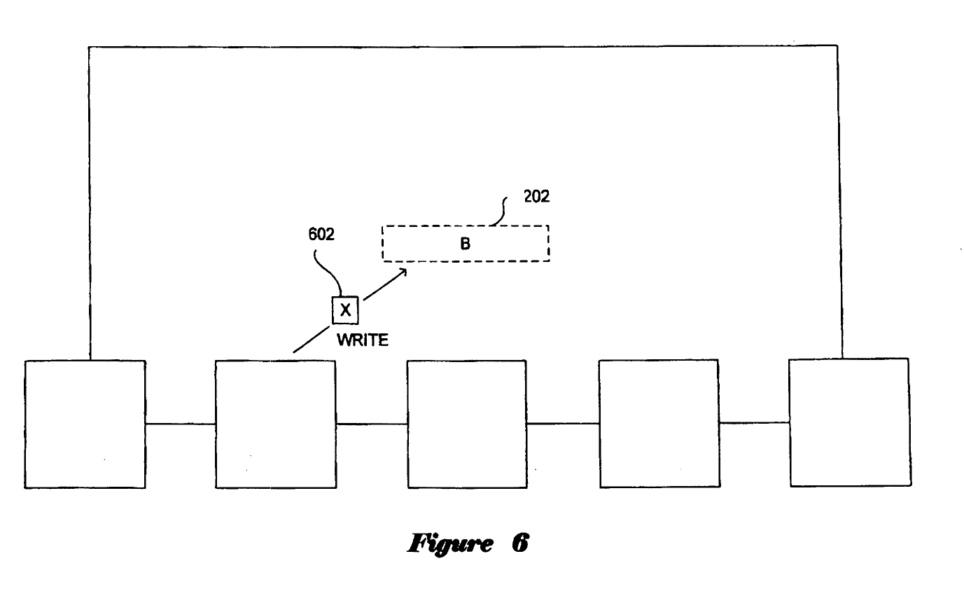

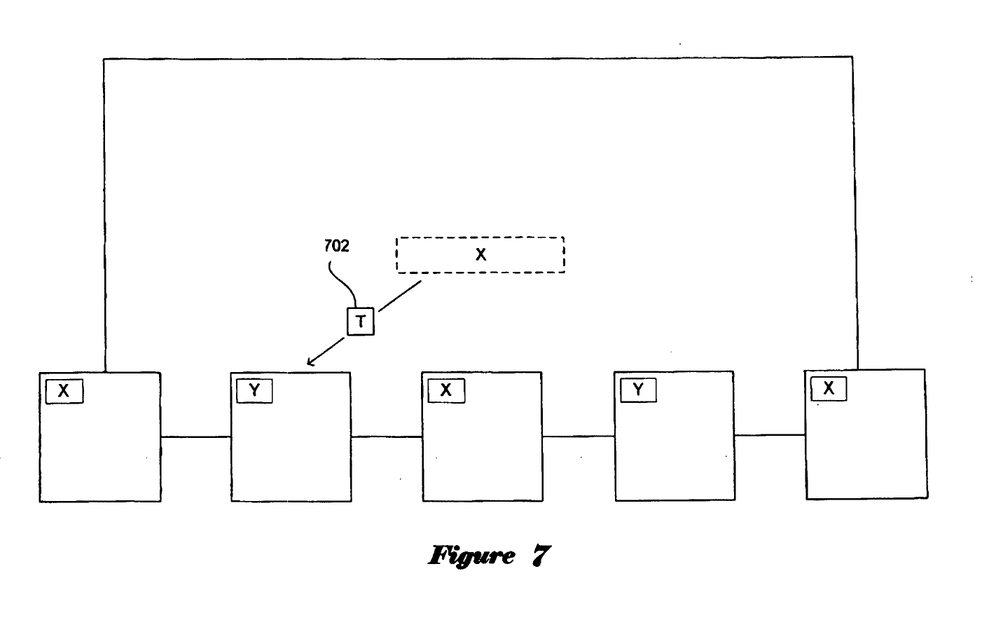

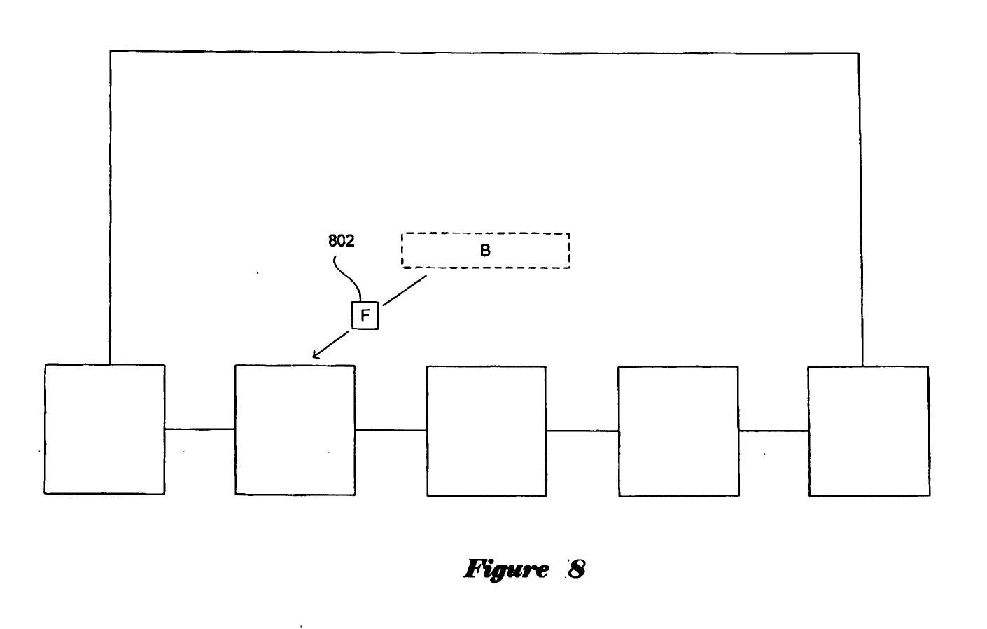

A process may also write a value to the distributed storage register. In FIG. 6, a process directs a WRITE message 602 to the distributed storage register 202, the WRITE message 602 including a new value “X” to be written to the distributed storage register 202. If the value transmitted to the distributed storage register successfully overwrites whatever value is currently stored in the distributed storage register, as shown in FIG. 7, then a Boolean value “TRUE” is returned 702 to the process that directed the WRITE request to the distributed storage register. Otherwise, as shown in FIG. 8, the WRITE request fails, and a Boolean value “FALSE” is returned 802 to the process that directed the WRITE request to the distributed storage register, the value stored in the distributed storage register unchanged by the WRITE request. In certain implementations, the distributed storage register returns binary values “OK” and “NOK,” with OK indicating successful execution of the WRITE request and NOK indicating that the contents of the distributed storage register are indefinite, or, in other words, that the WRITE may or may not have succeeded.

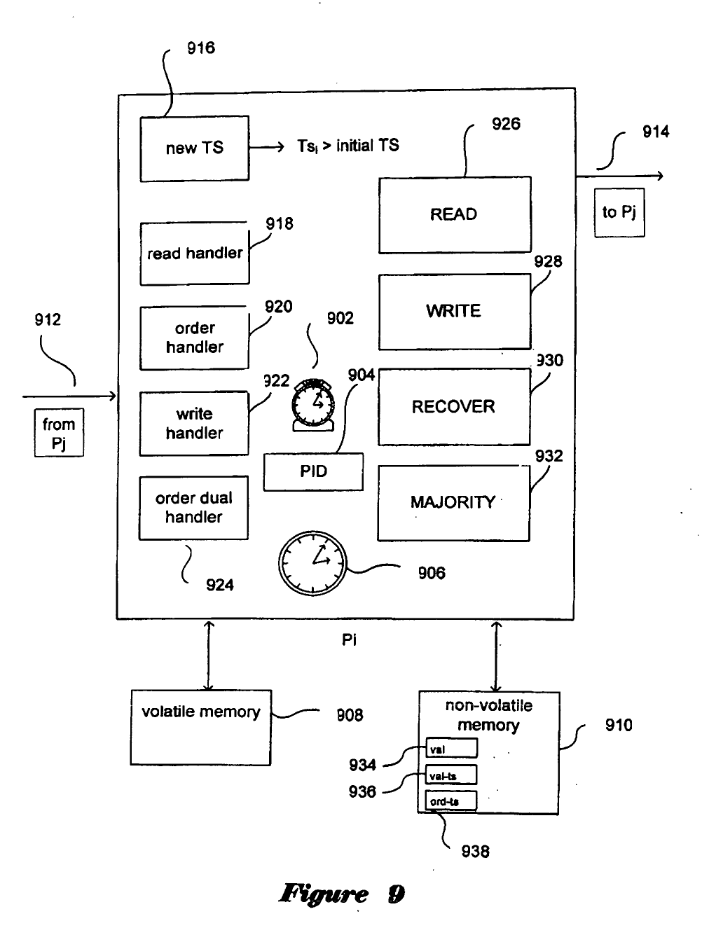

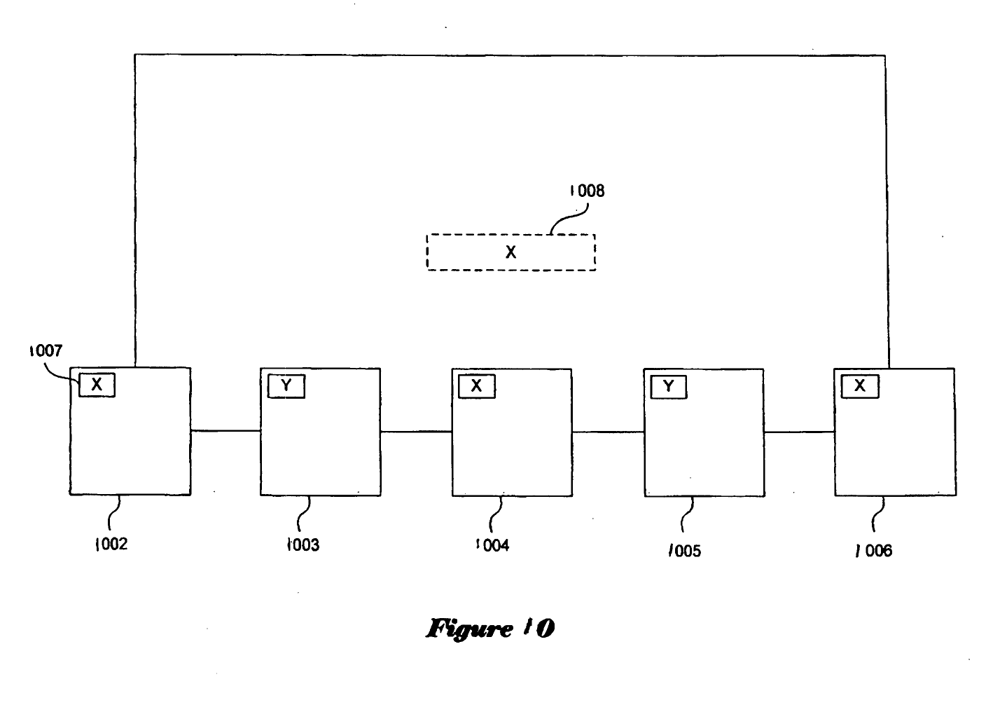

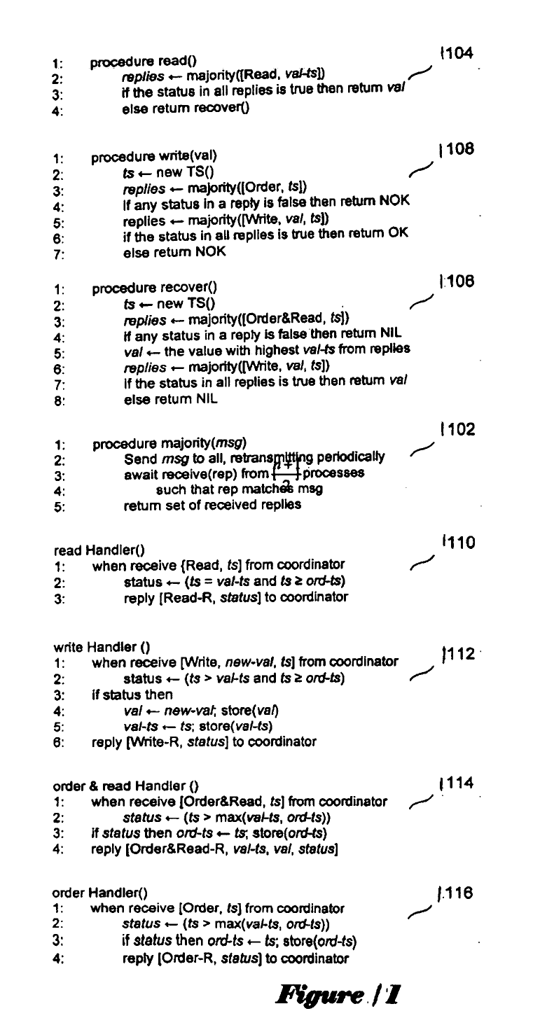

FIG. 9 shows the components used by a process or processing entity Pᵢ that implements, along with a number of other processes and/or processing entities, P_{j≠i}, a distributed storage register. A processor or processing entity uses three low level primitives: a timer mechanism 902, a unique ID 904, and a clock 906. The processor or processing entity Pᵢ uses a local timer mechanism 902 that allows Pᵢ to set a timer for a specified period of time, and to then wait for that timer to expire, with Pᵢ notified on expiration of the timer in order to continue some operation. A process can set a timer and continue execution, checking or polling the timer for expiration, or a process can set a timer, suspend execution, and be re-awakened when the timer expires. In either case, the timer allows the process to logically suspend an operation, and subsequently resume the operation after a specified period of time, or to perform some operation for a specified period of time, until the timer expires. The process or processing entity Pᵢ also has a reliably stored and reliably retrievable local process ID (“PID”) 904. Each processor or processing entity has a local PID that is unique with respect to all other processes and/or processing entities that together implement the distributed storage register. Finally, the processor processing entity Pᵢ has a real-time clock 906 that is roughly coordinated with some absolute time. The real-time clocks of all the processes and/or processing entities that together collectively implement a distributed storage register need not be precisely synchronized, but should be reasonably reflective of some shared conception of absolute time. Most computers, including personal computers, include a battery-powered system clock that reflects a current, universal time value. For most purposes, including implementation of a distributed storage register, these system clocks need not be precisely synchronized, but only approximately reflective of a current universal time.

Each processor or processing entity Pᵢ includes a volatile memory 908 and, in some embodiments, a non-volatile memory 910. The volatile memory 908 is used for storing instructions for execution and local values of a number of variables used for the distributed-storage-register protocol. The non-volatile memory 910 is used for persistently storing the variables used, in some embodiments, for the distributed-storage-register protocol. Persistent storage of variable values provides a relatively straightforward resumption of a process's participation in the collective implementation of a distributed storage register following a crash or communications interruption. However, persistent storage is not required for resumption of a crashed or temporally isolated processor's participation in the collective implementation of the distributed storage register. Instead, provided that the variable values stored in dynamic memory, in non-persistent-storage embodiments, if lost, are all lost together, provided that lost variables are properly re-initialized, and provided that a quorum of processors remains functional and interconnected at all times, the distributed storage register protocol correctly operates, and progress of processes and processing entities using the distributed storage register is maintained. Each process Pᵢ stores three variables: (1) val 934, which holds the current, local value for the distributed storage register; (2) val-ts 936, which indicates the time-stamp value associated with the current local value for the distributed storage register; and (3) ord-ts 938, which indicates the most recent timestamp associated with a WRITE operation. The variable val is initialized, particularly in non-persistent-storage embodiments, to a value NIL that is different from any value written to the distributed storage register by processes or processing entities, and that is, therefore, distinguishable from all other distributed-storage-register values. Similarly, the values of variables val-ts and ord-ts are initialized to the value “initialTS,” a value less than any time-stamp value returned by a routine “newTS” used to generate time-stamp values. Providing that val, val-ts, and ord-ts are together re-initialized to these values, the collectively implemented distributed storage register tolerates communications interruptions and process and processing entity crashes, provided that at least a majority of processes and processing entities recover and resume correction operation.

Each processor or processing entity Pᵢ may be interconnected to the other processes and processing entities P_{j≠i} via a message-based network in order to receive 912 and send 914 messages to the other processes and processing entities P_{j≠i}. Each processor or processing entity Pᵢ includes a routine “newTS” 916 that returns a timestamp TSᵢ when called, the timestamp TSᵢ greater than some initial value “initialTS.” Each time the routine “newTS” is called, it returns a timestamp TSᵢ greater than any timestamp previously returned. Also, any timestamp value TSᵢ returned by the newTS called by a processor or processing entity Pᵢ should be different from any timestamp TSⱼ returned by newTS called by any other processor processing entity Pⱼ. One practical method for implementing newTS is for newTS to return a timestamp TS comprising the concatenation of the local PID 904 with the current time reported by the system clock 906. Each processor or processing entity Pᵢ that implements the distributed storage register includes four different handler routines: (1) a READ handler 918; (2) an ORDER handler 920; (3) a WRITE handler 922; and (4) an ORDER&READ handler 924. It is important to note that handler routines may need to employ critical sections, or code sections single-threaded by locks, to prevent race conditions in testing and setting of various local data values. Each processor or processing entity Pᵢ also has four operational routines: (1) READ 926; (2) WRITE 928; (3) RECOVER 930; and (4) MAJORITY 932. Both the four handler routines and the four operational routines are discussed in detail, below.

Correct operation of a distributed storage register, and liveness, or progress, of processes and processing entities using a distributed storage register depends on a number of assumptions. Each process or processing entity Pᵢ is assumed to not behave maliciously. In other words, each processor or processing entity Pᵢ faithfully adheres to the distributed-storage-register protocol. Another assumption is that a majority of the processes and/or processing entities Pᵢ that collectively implement a distributed storage register either never crash or eventually stop crashing and execute reliably. As discussed above, a distributed storage register implementation is tolerant to lost messages, communications interruptions, and process and processing-entity crashes. When a number of processes or processing entities are crashed or isolated that is less than sufficient to break the quorum of processes or processing entities, the distributed storage register remains correct and live. When a sufficient number of processes or processing entities are crashed or isolated to break the quorum of processes or processing entities, the system remains correct, but not live. As mentioned above, all of the processes and/or processing entities are fully interconnected by a message-based network. The message-based network may be asynchronous, with no bounds on message-transmission times. However, a fair-loss property for the network is assumed, which essentially guarantees that if Pᵢ receives a message m from Pⱼ, then Pⱼ sent the message m, and also essentially guarantees that if Pᵢ repeatedly transmits the message m to Pⱼ, Pⱼ will eventually receive message m, if Pⱼ is a correct process or processing entity. Again, as discussed above, it is assumed that the system clocks for all processes or processing entities are all reasonably reflective of some shared time standard, but need not be precisely synchronized.

These assumptions are useful to prove correctness of the distributed-storage-register protocol and to guarantee progress. However, in certain practical implementations, one or more of the assumptions may be violated, and a reasonably functional distributed storage register obtained. In addition, additional safeguards may be built into the handler routines and operational routines in order to overcome particular deficiencies in the hardware platforms and processing entities.

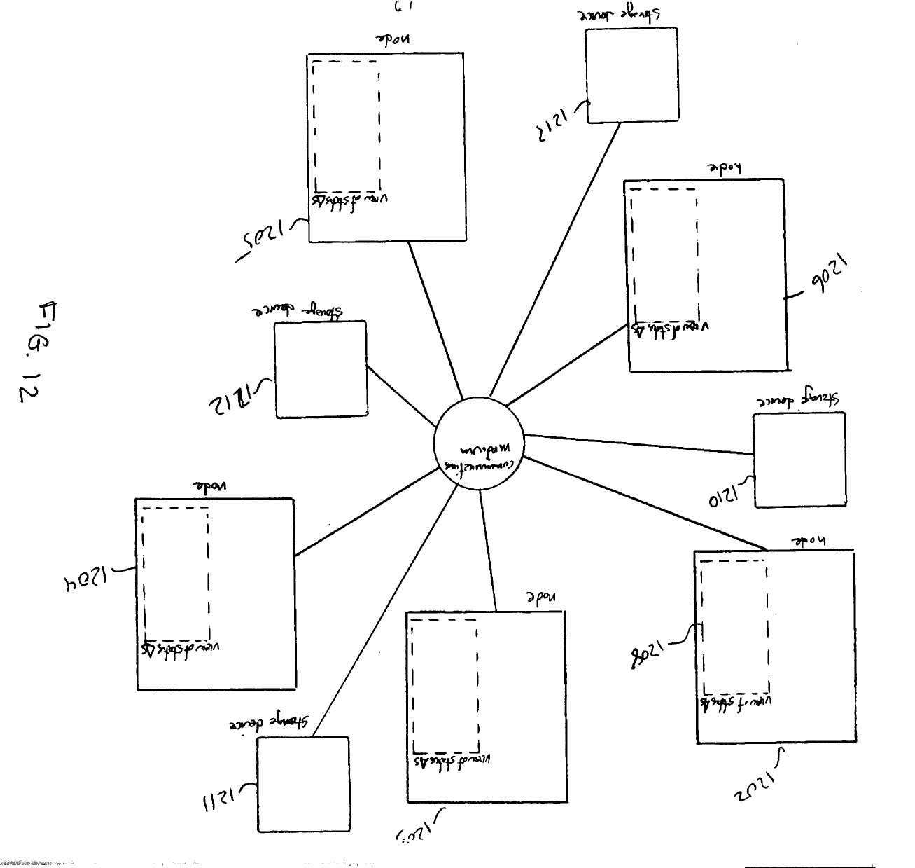

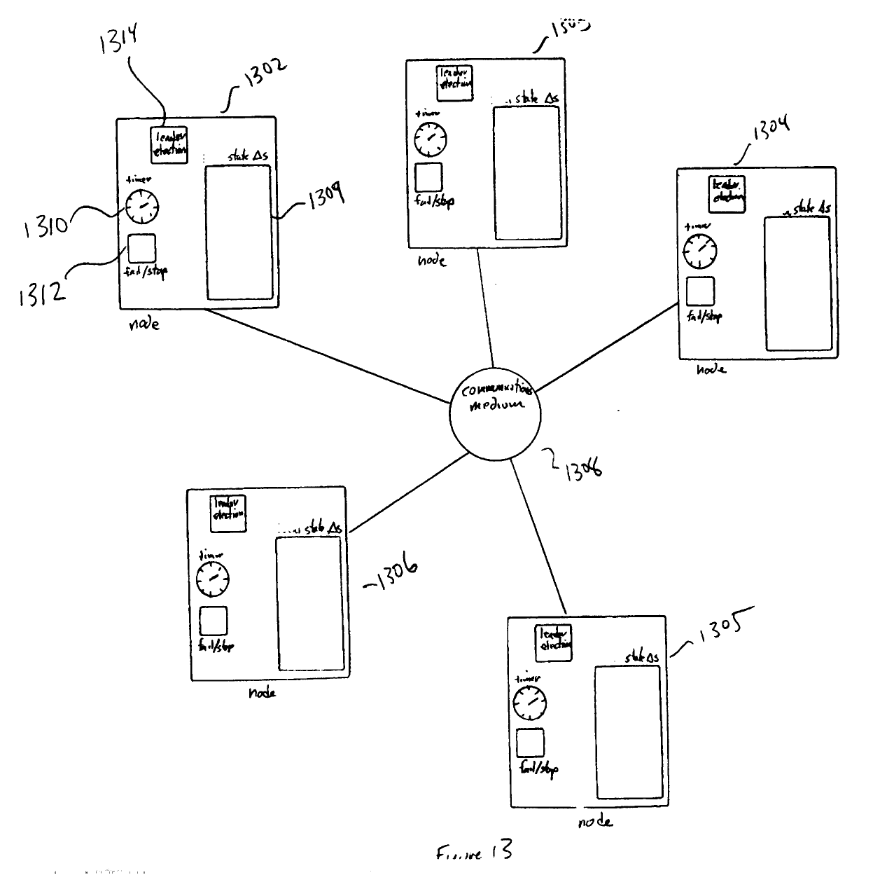

Operation of the distributed storage register is based on the concept of a quorum. FIG. 10 illustrates determination of the current value of a distributed storage register by means of a quorum. FIG. 10 uses similar illustration conventions as used in FIGS. 2-8. In FIG. 10, each of the processes or processing entities 1002-1006 maintains the local variable, val-ts, such as local variable 1007 maintained by process or processing entity 1002, that holds a local time-stamp value for the distributed storage register. If, as in FIG. 6, a majority of the local values maintained by the various processes and/or processing entities that collectively implement the distributed storage register currently agree on a time-stamp value val-ts, associated with the distributed storage register, then the current value of the distributed storage register 1008 is considered to be the value of the variable val held by the majority of the processes or processing entities. If a majority of the processes and processing entities cannot agree on a time-stamp value val-ts, or there is no single majority-held value, then the contents of the distributed storage register are undefined. However, a minority-held value can be then selected and agreed upon by a majority of processes and/or processing entities, in order to recover the distributed storage register. Alternatively, the distributed-storage-register value associated with the highest val-ts value may be considered to be the current value of the distributed storage register, provided that this value is distributed to a majority of the processes and/or processing entities using the recover operation prior to use of the distributed-storage-register value.

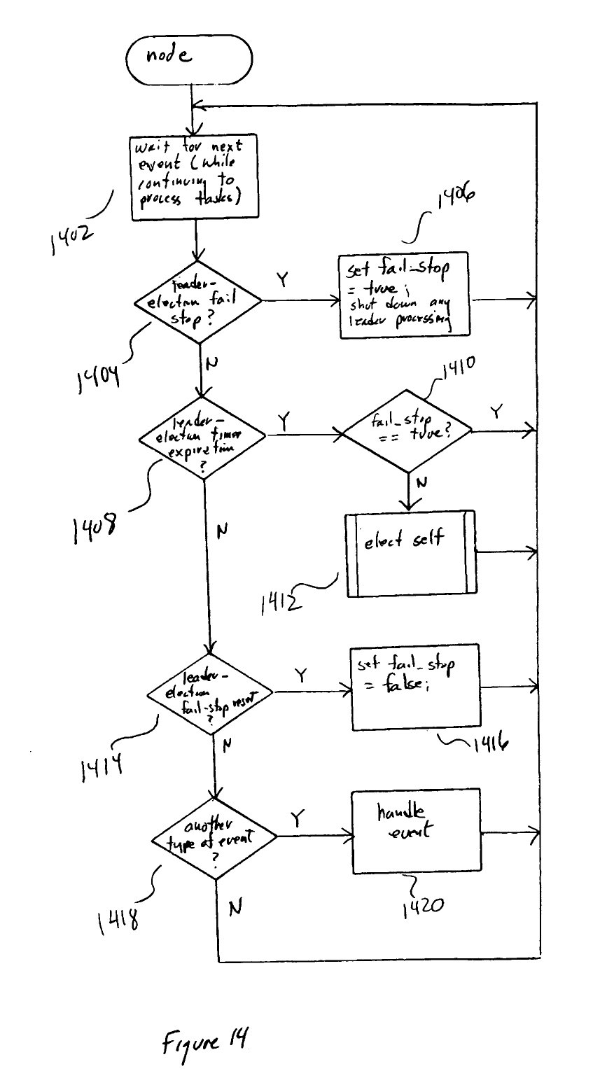

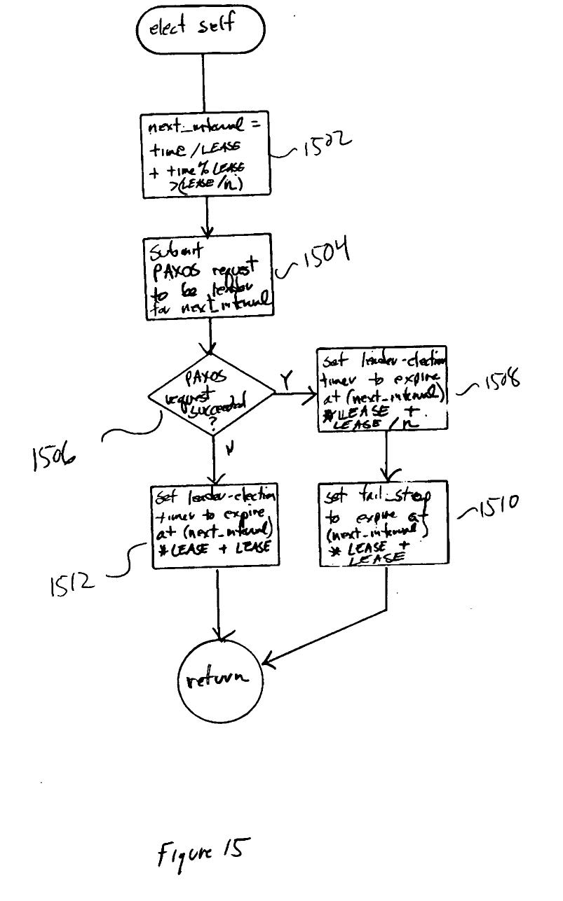

FIG. 11 shows pseudocode implementations for the routine handlers and operational routines shown diagrammatically in FIG. 9. It should be noted that these pseudocode implementations omit detailed error handling and specific details of low-level communications primitives, local locking, and other details that are well understood and straightforwardly implemented by those skilled in the art of computer programming. The routine “majority” 1102 sends a message, on line 2, from a process or processing entity Pᵢ to itself and to all other processes or processing entities O_{j≠i} that, together with Pᵢ, collectively implement a distributed storage register. The message is periodically resent, until an adequate number of replies are received, and, in many implementations, a timer is set to place a finite time and execution limit on this step. Then, on lines 3-4, the routine “majority” waits to receive replies to the message, and then returns the received replies on line 5. The assumption that a majority of processes are correct, discussed above, essentially guarantees that the routine “majority” will eventually return, whether or not a timer is used. In practical implementations, a timer facilitates handling error occurrences in a timely manner. Note that each message is uniquely identified, generally with a timestamp or other unique number, so that replies received by process Pᵢ can be correlated with a previously sent message.

The routine “read” 1104 reads a value from the distributed storage register. On line 2, the routine “read” calls the routine “majority” to send a READ message to itself and to each of the other processes or processing entities P_{j≠i}. The READ message includes an indication that the message is a READ message, as well as the time-stamp value associated with the local, current distributed storage register value held by process Pᵢ, val-ts. If the routine “majority” returns a set of replies, all containing the Boolean value “TRUE,” as determined on line 3, then the routine “read” returns the local current distributed-storage-register value, val. Otherwise, on line 4, the routine “read” calls the routine “recover.”

The routine “recover” 1106 seeks to determine a current value of the distributed storage register by a quorum technique. First, on line 2, a new timestamp ts is obtained by calling the routine “newTS.” Then, on line 3, the routine “majority” is called to send ORDER&READ messages to all of the processes and/or processing entities. If any status in the replies returned by the routine “majority” are “FALSE,” then “recover” returns the value NIL, on line 4. Otherwise, on line 5, the local current value of the distributed storage register, val, is set to the value associated with the highest value timestamp in the set of replies returned by routine “majority.” Next, on line 6, the routine “majority” is again called to send a WRITE message that includes the new timestamp ts, obtained on line 2, and the new local current value of the distributed storage register, val. If the status in all the replies has the Boolean value “TRUE,” then the WRITE operation has succeeded, and a majority of the processes and/or processing entities now concur with that new value, stored in the local copy val on line 5. Otherwise, the routine “recover” returns the value NIL.

The routine “write” 1108 writes a new value to the distributed storage register. A new timestamp, ts, is obtained on line 2. The routine “majority” is called, on line 3, to send an ORDER message, including the new timestamp, to all of the processes and/or processing entities. If any of the status values returned in reply messages returned by the routine “majority” are “FALSE,” then the value “NOK” is returned by the routine “write,” on line 4. Otherwise, the value val is written to the other processes and/or processing entities, on line 5, by sending a WRITE message via the routine “majority.” If all the status vales in replies returned by the routine “majority” are “TRUE,” as determined on line 6, then the routine “write” returns the value “OK.” Otherwise, on line 7, the routine “write” returns the value “NOK.” Note that, in both the case of the routine “recover” 1106 and the routine “write,” the local copy of the distributed-storage-register value val and the local copy of the timestamp value val-ts are both updated by local handler routines, discussed below.

Next, the handler routines are discussed. At the onset, it should be noted that the handler routines compare received values to local-variable values, and then set local variable values according to the outcome of the comparisons. These types of operations may need to be strictly serialized, and protected against race conditions within each process and/or processing entity for data structures that store multiple values. Local serialization is easily accomplished using critical sections or local locks based on atomic test-and-set instructions. The READ handler routine 1110 receives a READ message, and replies to the READ message with a status value that indicates whether or not the local copy of the timestamp val-ts in the receiving process or entity is equal to the timestamp received in the READ message, and whether or not the timestamp ts received in the READ message is greater than or equal to the current value of a local variable ord-ts. The WRITE handler routine 1112 receives a WRITE message determines a value for a local variable status, on line 2, that indicates whether or not the local copy of the timestamp val-ts in the receiving process or entity is greater than the timestamp received in the WRITE message, and whether or not the timestamp ts received in the WRITE message is greater than or equal to the current value of a local variable ord-ts. If the value of the status local variable is “TRUE,” determined on line 3, then the WRITE handler routine updates the locally stored value and timestamp, val and val-ts, on lines 4-5, both in dynamic memory and in persistent memory, with the value and timestamp received in the WRITE message. Finally, on line 6, the value held in the local variable status is returned to the process or processing entity that sent the WRITE message handled by the WRITE handler routine 1112.

The ORDER&READ handler 1114 computes a value for the local variable status, on line 2, and returns that value to the process or processing entity from which an ORDER&READ message was received. The computed value of status is a Boolean value indicating whether or not the timestamp received in the ORDER&READ message is greater than both the values stored in local variables val-ts and ord-ts. If the computed value of status is “TRUE,” then the received timestamp ts is stored into both dynamic memory and persistent memory in the variable ord-ts.

Similarly, the ORDER handler 1116 computes a value for a local variable status, on line 2, and returns that status to the process or processing entity from which an ORDER message was received. The status reflects whether or not the received timestamp is greater than the values held in local variables val-ts and ord-ts. If the computed value of status is “TRUE,” then the received timestamp ts is stored into both dynamic memory and persistent memory in the variable ord-ts.

Using the distributed storage register method and protocol, discussed above, shared state information that is continuously consistently maintained in a distributed data-storage system can be stored in a set of distributed storage registers, one unit of shared state information per register. The size of a register may vary to accommodate different natural sizes of units of shared state information. The granularity of state information units can be determined by performance monitoring, or by analysis of expected exchange rates of units of state information within a particular distributed system. Larger units incur less overhead for protocol variables and other data maintained for a distributed storage register, but may result in increased communications overhead if different portions of the units are accessed at different times. It should also be noted that, while the above pseudocode and illustrations are directed to implementation of a single distributed storage register, these pseudocode routines can be generalized by adding parameters identifying a particular distributed storage register, of unit of state information, to which operations are directed, and by maintaining arrays of variables, such as val-ts, val, and ord-ts, indexed by the identifying parameters.

### Disk Paxos

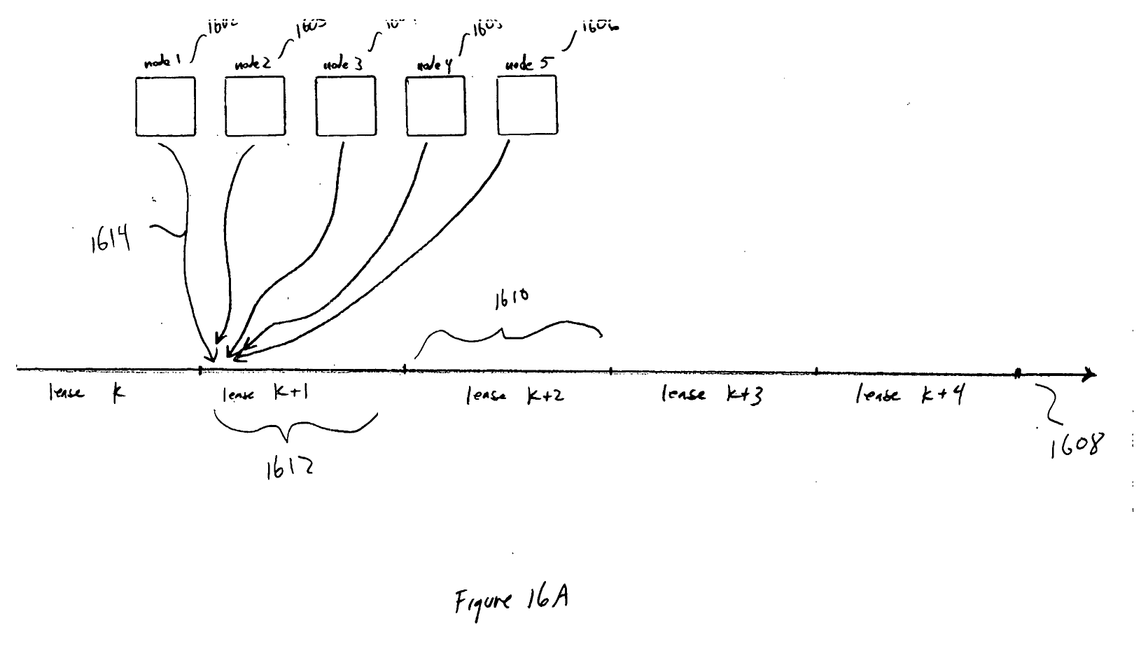

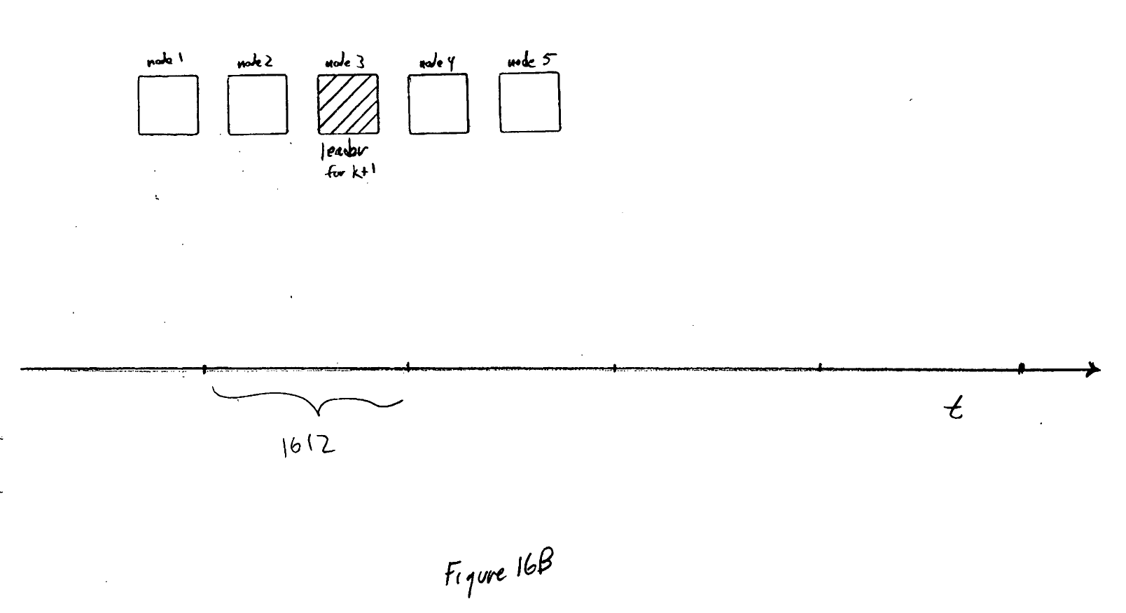

Disk Paxos and active-disk Paxos are two additional distributed-computing techniques similar to Paxos. However, while Paxos distributes a global, master list of committed state-change requests over the nodes of a distributed computer system, disk Paxos and active-disk Paxos distribute a global list of state changes over a number of mass-storage devices. FIG. 12 illustrates a disk-Paxos or active-disk-Paxos distributed computer system. As shown in FIG. 12, each computing node 1202-1206 includes a view of the global state-change list, such as the view 1208 in node 1202. A global state-change list is distributed across mass-storage devices 1210-1213. In disk Paxos and active disk Paxos, a quorum of mass-storage devices, rather than computing nodes, is required for committing state-change requests. Thus, state-change requests may succeed in a disk Paxos or active disk Paxos system when even a single computing node is active. In active-disk Paxos, a subset of disk nodes are generally involved in quorums, allowing for better scalability to large systems. Both disk Paxos and active-disk Paxos provide functionality equivalent to Paxos. All three protocols allow for maintaining a shared, ordered, sequential, global list of committed state changes across the entire distributed computer system, allow individual nodes of a distributed computer system to request state changes, and resolve request-submission contention.

### Embodiments of the Present Invention

Embodiments of the present invention employ a quorum-based distributed consensus system, such as Paxos, along with two additional functionalities included in each node of the distributed system, in order to provide for a robust and reliable strong-leader election within a distributed computer system. A strong leader is a leader that, once acquiring a leadership role, continues in the leadership role for an extended period of time or over an extended computational process. By contrast, a weak leader assumes a leadership role only for a particular, well-bounded task or period of time, after which all or a large number of nodes contend for the leadership role for a subsequent, well-bounded task or period of time.

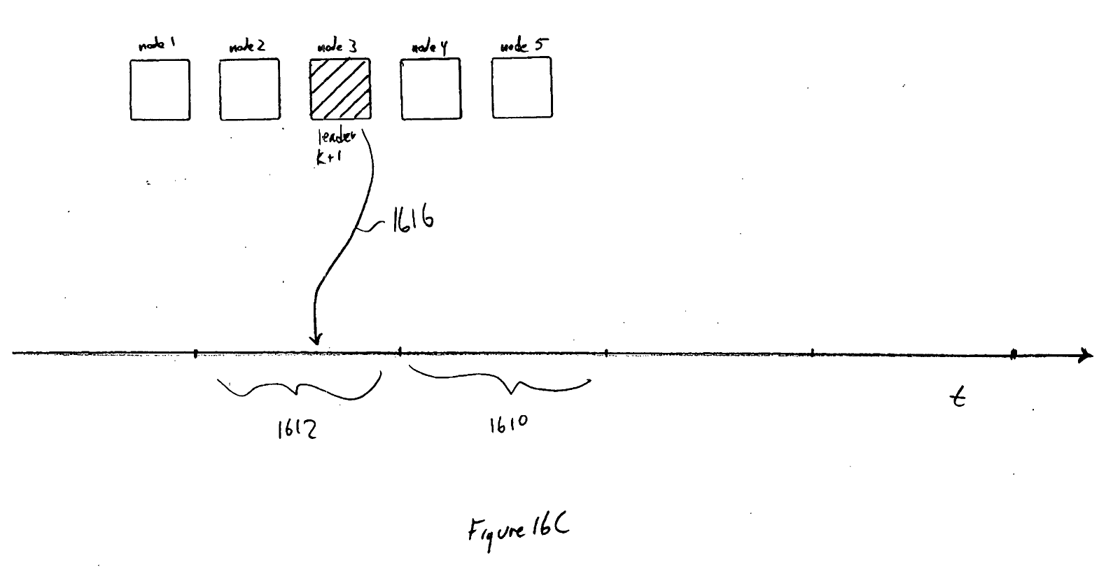

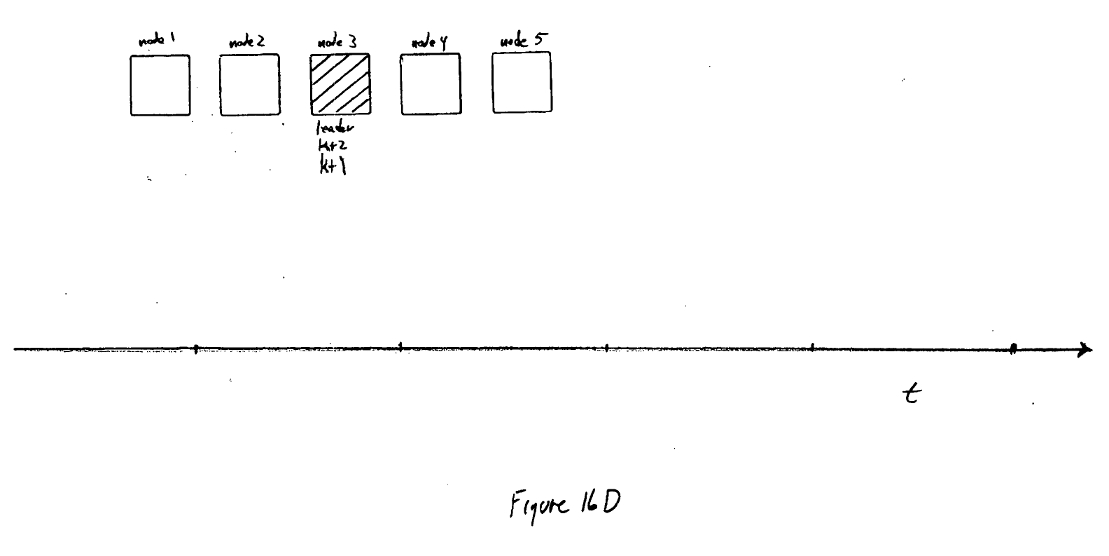

FIG. 13 illustrates an exemplary distributed computer system in which strong-leader election may be practiced according to methods and systems of the present invention. In FIG. 13, five computing nodes 1302-1306 are linked together by a communications medium 1308. Each node includes a local state-change list or view of a global state-change list, such as state-change list 1309 in node 1302, provided according to a Paxos, disk-Paxos, or Paxos-like distributed consensus service or a distributed-storage-register-based consensus service. Each node also includes timing functionality, such as timing functionality 1310 in node 1302, a fail-stop mechanism, such as fail-stop mechanism 1312 in node 1302, and leader-election functionality, generally implemented in software or firmware, such as leader-election functionality 1314 in node 1302.

The timing functionality includes a node clock that indicates regular intervals in time, such as milliseconds, generally with monotonically increasing values based on an arbitrary starting point. The timing functionalities of all of the nodes are synchronized at some level of precision. In other words, any disparities between times indicated by timing functionalities of the different nodes of a distributed computer system, at any given instant in time, are less than a maximum disparity value. Associated with the timing functionality are software and/or hardware timers that can be set to expire, and to provide notice of expiration, after an arbitrary interval of time.

The fail-stop functionality provides a means to signal a fail-stop condition and discontinue computation related to the signaled fail-stop condition. It is desirable that the fail-stop functionality be implemented at least partially in hardware, to ensure that time lags between recognition of a fail-stop condition and fail-stop signaling are minimized. For example, a fail-stop device may involve high-priority hardware interrupts and non-blocking interrupt handlers.

The leader-election functionality, generally implemented in software, or firmware, or a combination of software and firmware, implements the strong-leader election method of the present invention. The leader-election functionality is described below, using several control-flow diagrams. In general, the strong-leader election methods of the present invention provide for self election by nodes. Nodes issue Paxos or Paxos-like state-change requests to request that they become the leader for a next lease period. The current leader, if still active, is provided an advantage of requesting re-election at time part-way through the current lease period as which the current leader's request for re-election is unopposed.

It is assumed that, upon node initialization or upon re-initialization of a node following failure and recovery of the node, the timing functionality of the node is synchronized with the timing functionalities of the other, active nodes within the distributing computing system. Furthermore, all nodes are initialized or re-initialized to include a constant time value LEASE, which represents the length, in time increments, of a lease period for holding a leadership role, and to include a value n that is used to generate, by division, a fraction of the lease time LEASE at which current leaders request re-election. The leader re-election request period, LEASE/n, needs to be sufficiently less than the lease period that a current leader succeeds in re-election despite network delays, scheduling delays, intra-node timer misalignment, and other such potential sources of delay.

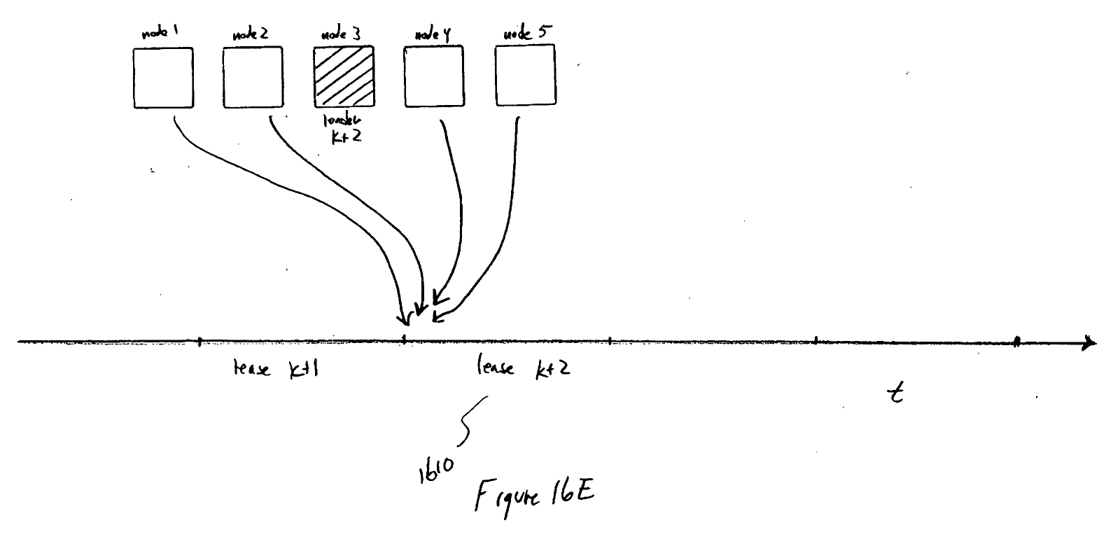

FIG. 14 is a control-flow diagram illustrating general node operation and strong-leader election, according to embodiments of the present invention. Node operation can be considered, at a high level, to be an endless loop in which the node recognizes and handles events. It is assumed that, when events occur simultaneously, event processing hardware and software sequentially order and prioritize the events, such as the interrupt ordering and prioritization that occurs within operating systems. In step 1402 of the endless loop, the node waits for a next event, while continuing to process any computational tasks currently being executed by one or more processes or threads within the node. Upon occurrence of an event, the node first determines, in step 1404, whether a leader-election fail-stop event has occurred. If so, then in step 1406, the node sets a node global variable fail_stop to TRUE, and may additionally actively shut down any current processing activities related to a leadership role previously assumed by the node. In alternative embodiments, in which it is important that a leader that has failed to re-elect itself immediately halt any leader-role-related processing, a hardware-reset may instead be generated by a hardware timer, to immediately halt leader operation. If a leadership-election fail-stop event has not occurred, then in step 1408, the node checks whether a leader-election timer has expired. If a leader-election timer has expired, then, in step 1410, the node determines whether the global node variable fail_stop is TRUE. If so, then no action is taken. Otherwise, the node executes the “elect self” routine, in step 1412, to be discussed below. If a leader-election timer expiration has not occurred, then, in step 1414, the node determines whether a leader-election fail-stop-reset event has occurred. If so, then the global node variable fail_stop is set to FALSE, in step 1416. If a leader-election fail-stop-reset event has not occurred then, in step 1418, another event has been detected, then that event is handled in step 1420. In other words, step 1420 represents handling of myriad non-leader-election-related events that occur within a node during node operation. In summary, a node carries out computational tasks while, at the same time, monitoring for the occurrence of leader-election fail-stop events, leader-election fail-stop-reset events, and expiration of leader-election timers. When a leader-election fail-stop event occurs, the node discontinues processing any leader-related tasks. When a leader-election timer expires, the node calls the routine “elect self,” described below, to attempt to elect itself to a leadership role.

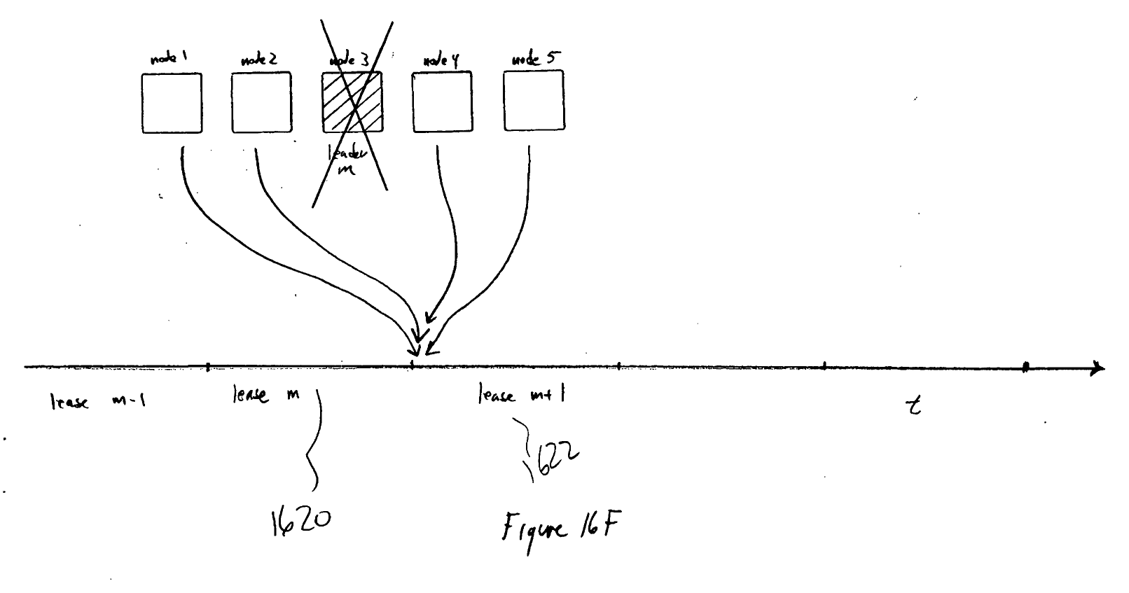

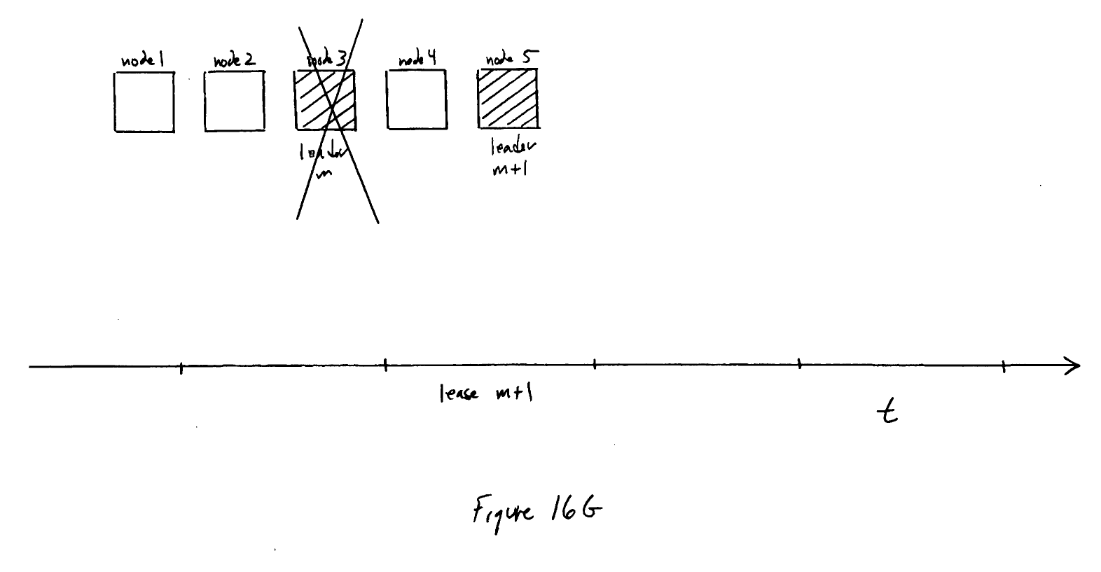

FIG. 15 is a control-flow diagram illustrating the routine “elect self,” which represents an embodiment of the present invention. In step 1502, the routine determines the value for a next lease interval next_interval. In the embodiment shown in FIG. 15, a next-interval value is determined by integer division of the current time by the LEASE period, with the value incremented when the current time is closer to onset of a subsequent lease interval than to onset of the current lease interval. Next, in step 1504, the routine issues a Paxos state-change request requesting that the node be designated leader for the lease period indicated by the value of the variable next_interval. If the request succeeds, as determined in step 1506, then the node has become the leader for the next lease period, and sets the leader-election timer to expire at a fraction LEASE/n of the next lease interval in step 1508. The node then sets the fail-stop functionality to expire at the end of the next lease period in step 1510. The node then assumes a leadership role for the next lease time period. Otherwise, if the Paxos request does not succeed, then, in step 1512, the node sets the leader-election timer to expire at the end of the next lease period. By setting the leader-election timers to a fraction of the next lease period, in step 1508, when the node is the leader, the node ensures that, should the node continue to be active, the node will always request re-election unopposed by other nodes within the distributed computer system.

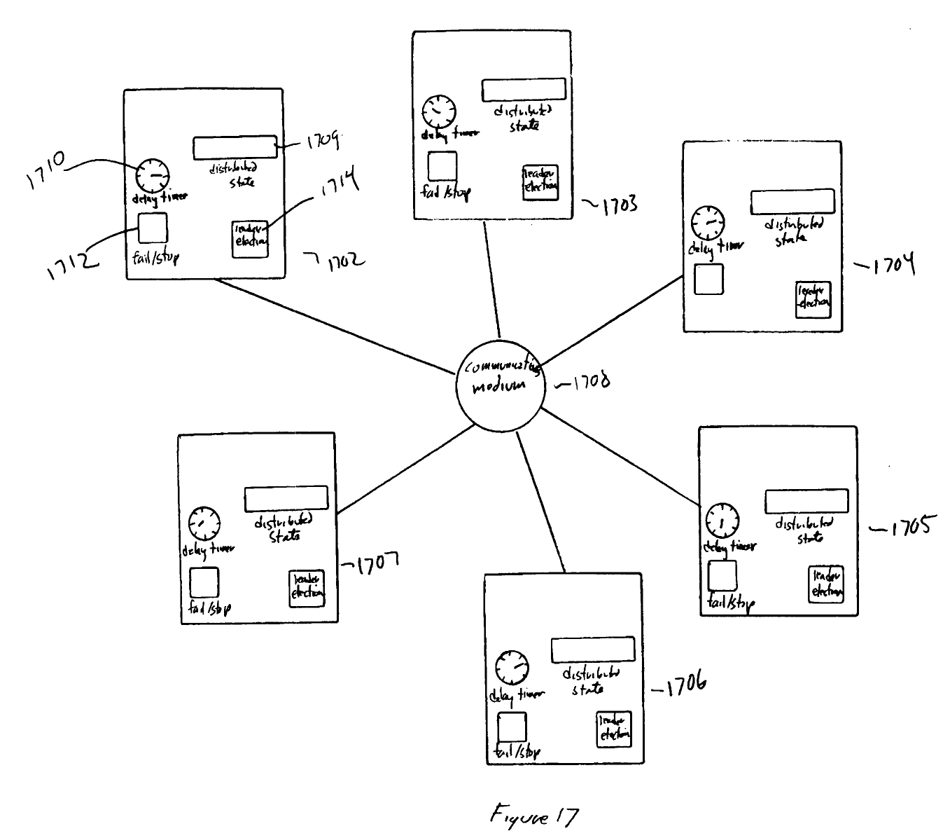

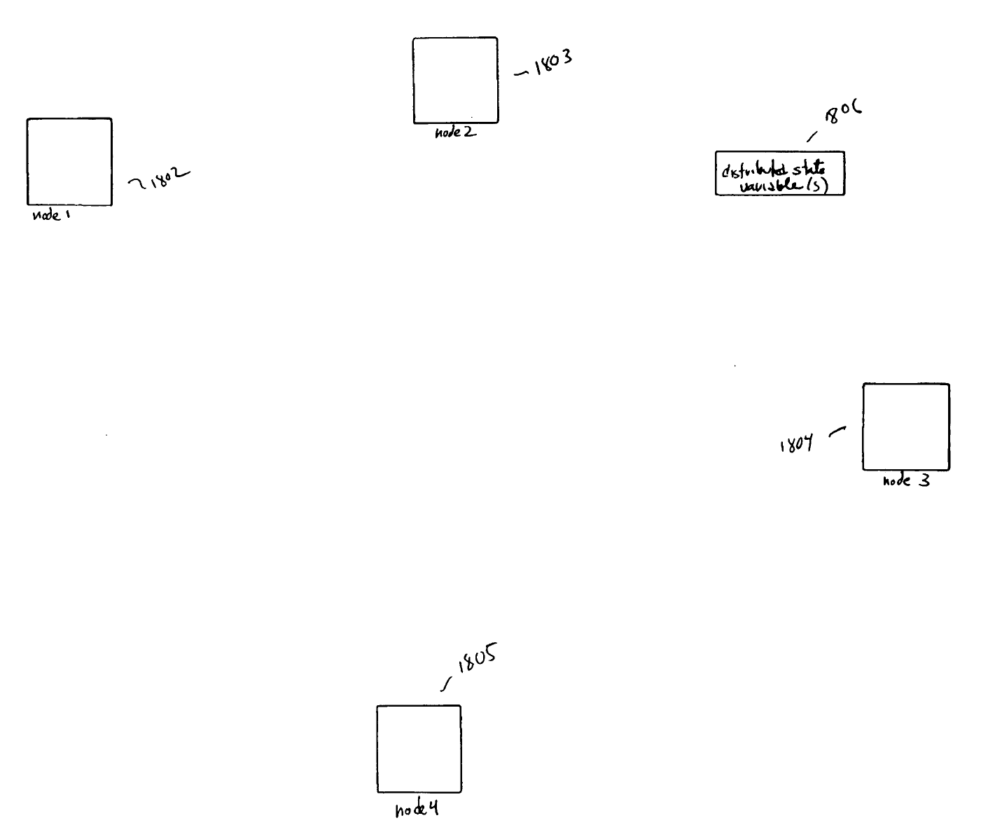

FIGS. 16A-G illustrate the strong-leader election method of the present invention. FIGS. 16A-G all use the same illustration conventions, next described with reference to FIG. 16A. In FIG. 16A, there are five nodes (nodes 1-5) 1602-1606. Events are discussed with respect to a time line 1608 that is divided into discrete, contiguous lease periods, such as lease period 1610. In FIG. 16A, no node is currently leader, and all nodes have been initialized to contend for a leadership role as soon as the lease period k+1 1612 begins. The request for a leadership role is represented for each node by an arrow pointing to the time line, such as arrow 1614 representing a request for the leadership role made by node 1602.

According to the Paxos protocol, only one of the simultaneous or close-to-simultaneous requests for the leadership role, shown in FIG. 16A, succeeds. Assuming that the request issued by node 3 1604 succeeds, then, as shown in FIG. 16B, node 3 is designated as the leader for lease period k+1 1612, and immediately begins to execute leader-related processing.

As shown in FIG. 16C, assuming n is equal to 2, node 3 requests the leadership role for the next lease period k+2 1610 halfway through the current lease period 1612, as represented by arrow 1616. Because all other, non-leader nodes wait until the start of the next lease period to request a leadership role, the request by node 3 proceeds unopposed, and therefore succeeds. Node 3 is designated the leader both for the current lease period k+1 and for the subsequent lease period k+2. At the beginning of lease period k+2 1610, as shown in FIG. 16E, the remaining nodes issue leadership-role requests, following the expiration of their leader-election timers. However, node 3 has already succeeded in obtaining leadership for lease period n+2, so these requests fail. Although not shown in a control-flow diagram, a Paxos, Paxos-like, or distributed-storage-register protocol is supplemented so refuse a second and any additional, subsequent requests for the leadership role for a particular lease period. Disk Paxos and active-disk Paxos do not need to be so supplemented, since these distributed consensus services fail a request made by a node or process that is not locally updated to see all recent state changes made by other nodes or processes. As long as node 3 continues to operate, node 3 remains the leader.

If, as shown in FIG. 16F, node 3 fails prior to the point LEASE/n within lease period m, then node 3 will fail to request a leadership role for lease period m+1 1622. Therefore, when the remaining non-leader nodes request a leadership role at the beginning of lease period m+1, one of the other nodes will assume leadership for lease period m+1 as shown in FIG. 16G.

The strong-leader-election method of the present invention therefore ensures that, even when a leader node fails, the leadership role resumes at most after a period equal to the lease period plus the fractional lease period at which leader nodes request re-election. Furthermore, once elected to a leadership role, a node can retain the leadership role as long as the node remains active and desires the leadership role. At any point in time, the leader node may surrender the leadership role by failing to request the leadership role for the subsequent lease period and optionally disabling fail-safe functionality.

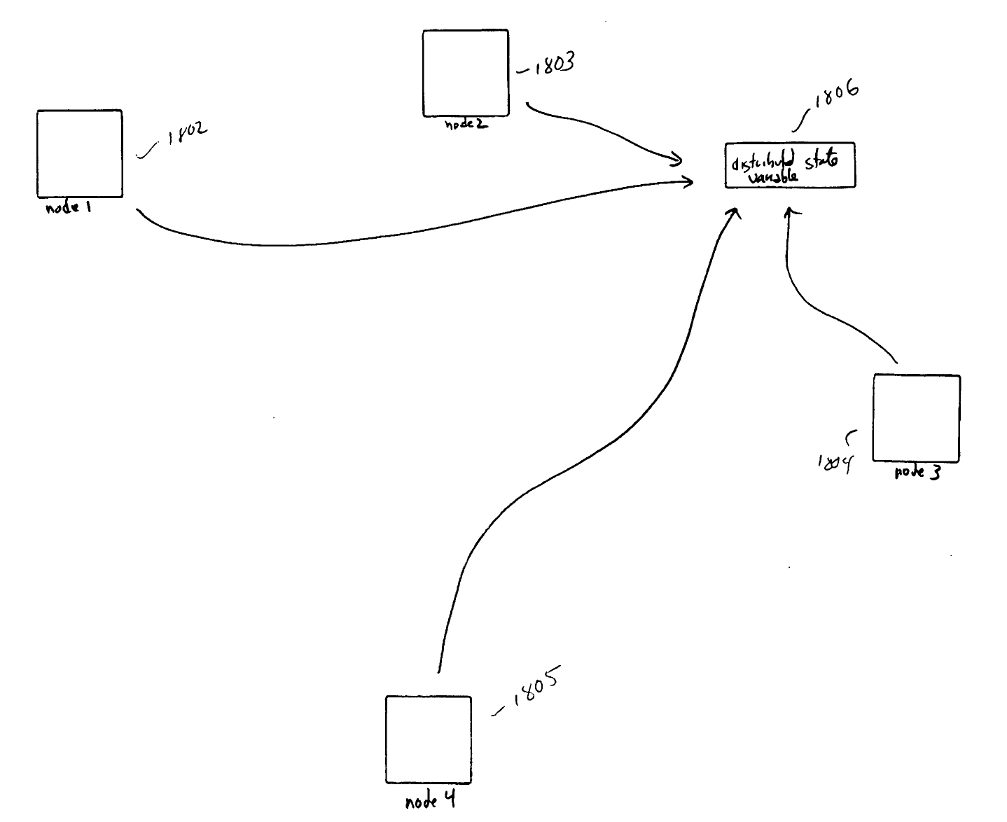

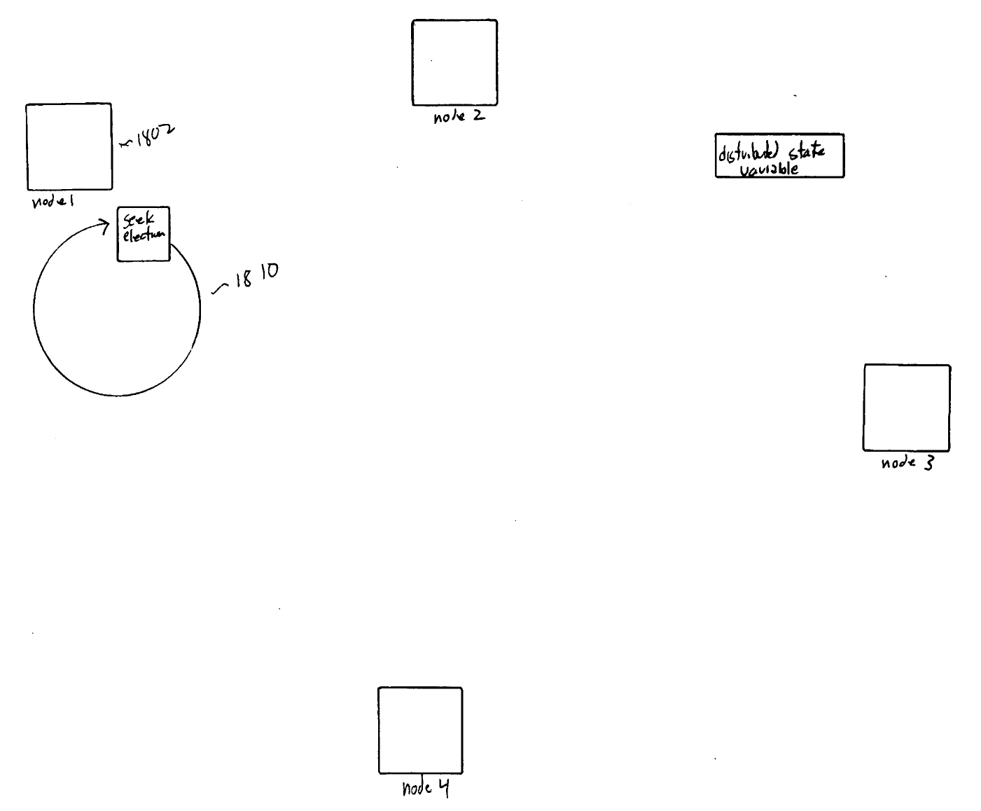

While the above-described embodiment employs roughly synchronized, absolute-time-reflecting node clocks, alternative implementations use unsynchronized delay timers in each node. FIG. 17 illustrates, in similar fashion to FIG. 13, an alternative distributed computer system in which strong-leader election may be practiced according to methods and systems of the present invention. In FIG. 17, six computing nodes 1702-1707 are linked together by a communications medium 1708. Each node includes a local view of a global variable indicating the current leader node, such as local view 1709 in node 1702, provided according to a Paxos, disk-Paxos, or Paxos-like distributed consensus service or a distributed-storage-register-based consensus service. Each node also includes a local delay timer, such as local delay timer 1710 in node 1702, a fail-stop mechanism, such as fail-stop mechanism 1712 in node 1702, and leader-election functionality, generally implemented in software or firmware, such as leader-election functionality 1714 in node 1702. The delay timers of the nodes are not synchronized with one another, unlike the node clocks of the above, first-described embodiment of the present invention. By contrast, the fail-stop mechanisms and leader-election functionalities are similar to, and play similar roles, as the fail-stop mechanisms and leader-election functionalities in the above, first-described embodiment of the present invention. As with the above, first-described embodiment of the present invention, each node includes, or has access to, a lease period defined by a constant LEASE and a fractional lease period defined by a value n used to compute the fractional lease period as LEASE/n. The control-flow diagram illustrating general node operation shown in FIG. 14 is applicable to the alternative embodiments of the present invention, with the exception that a different routine is called in step 1412.

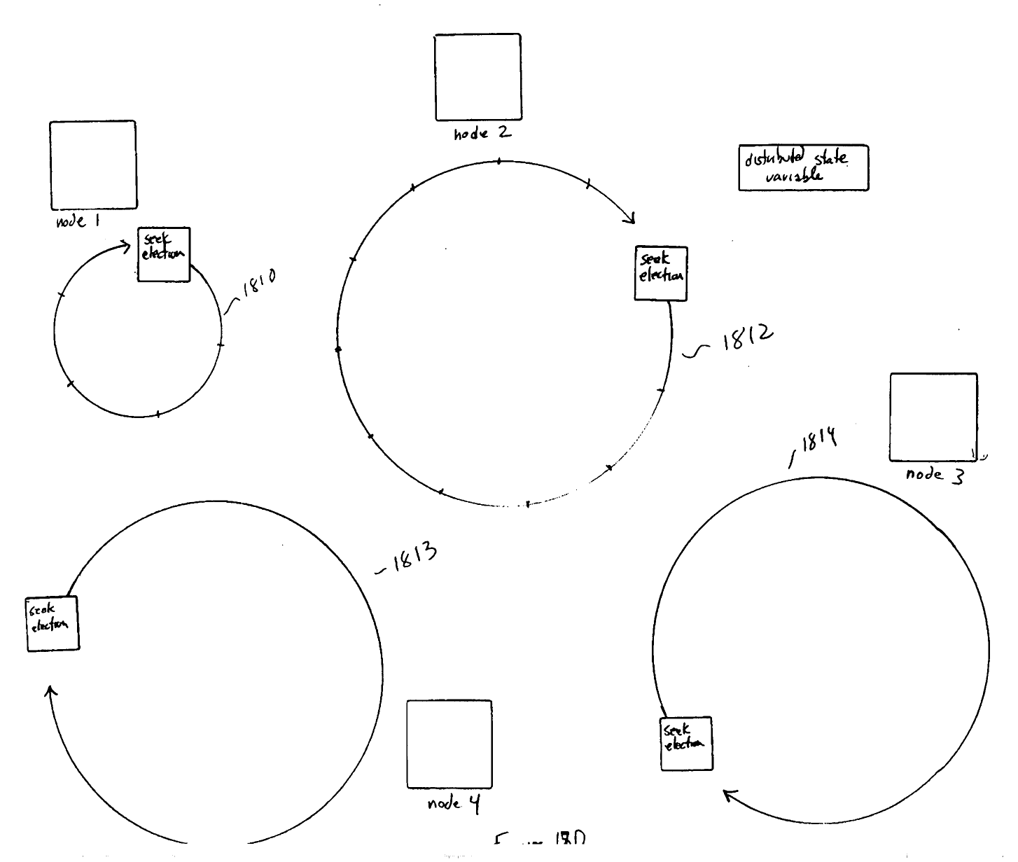

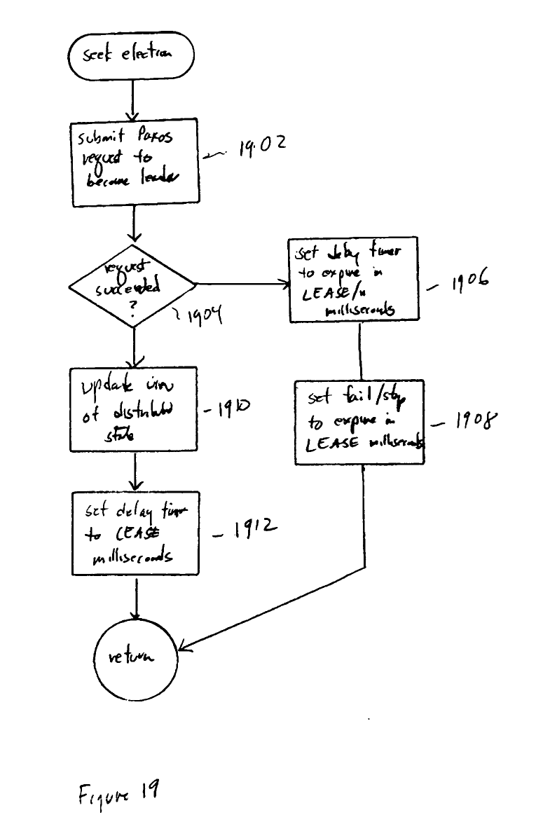

FIGS. 18A-D illustrate operation of delay-timer-based alternative embodiments of the present invention. In FIG. 18A, four computing nodes 1802-1805 that together employ a distributed consensus system to implement a distributed state variable or state variables 1806 that store a value indicative of the current leader node, and, in certain embodiments, other related information. At power-on, after failure of a leader node, and at other such points, some or all of the computing nodes may attempt to change the state variable in order to acquire leadership, as shown in FIG. 18B. As shown in FIG. 18C, one of the competing computing nodes is guaranteed, by the distributed consensus service, to acquire leadership, while the others' requests for leadership fail. In FIG. 18C, node 1 (1802) successfully acquired leadership, and has established a re-election cycle 1810 in which the node seeks re-election following each period of time LEASE/n. The remaining nodes 1803-1805 failed to acquire leadership, as shown in FIG. 18D, and therefore establish election cycles 1812-1814 in which each non-leader node seeks election following each period of time LEASE. In FIG. 18D, and in subsequent figures, the longer non-leader election cycles are shown as circles with larger diameters than the re-election cycle 1810 of the current leader node. In the alternative embodiments, the absolute time of each node's actions is irrelevant. Because, in the alternative embodiments, a nodes reference a local delay timer to decide when to seek election or re-election, rather than a node clock, each node may seek election at any time with respect to the actions taken by the remaining nodes, rather than within some range of times about an absolute time recognized by all nodes.

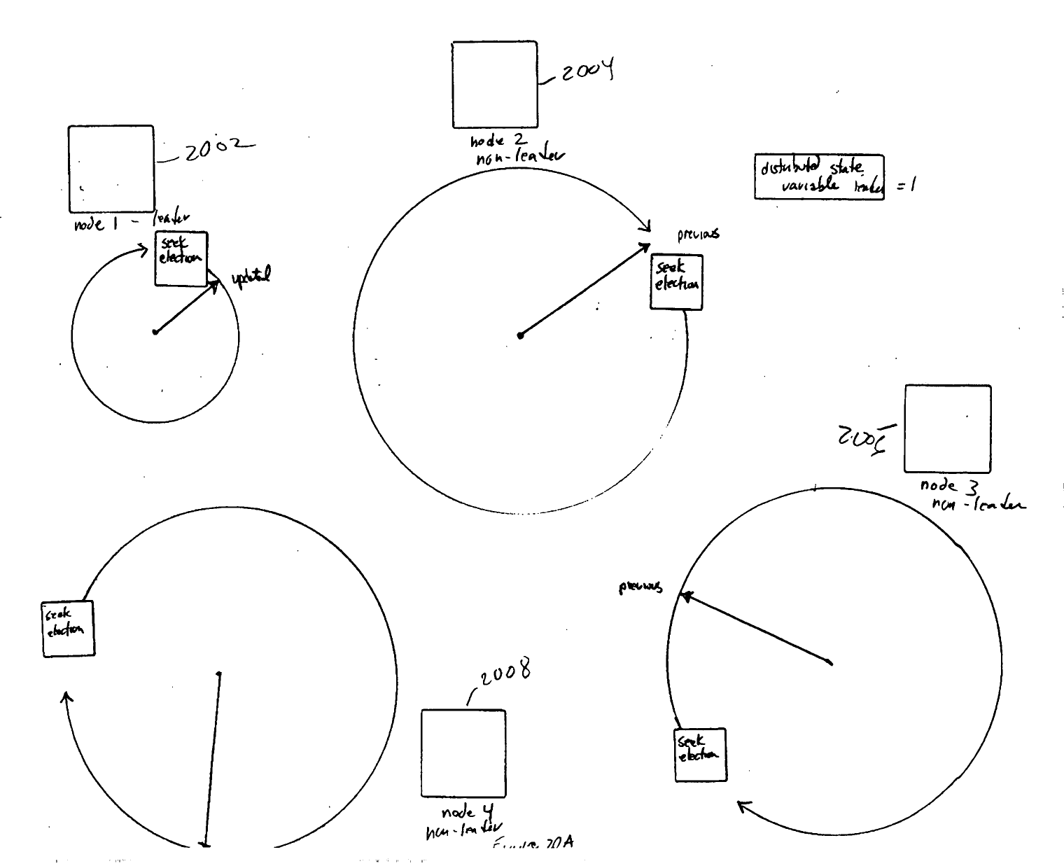

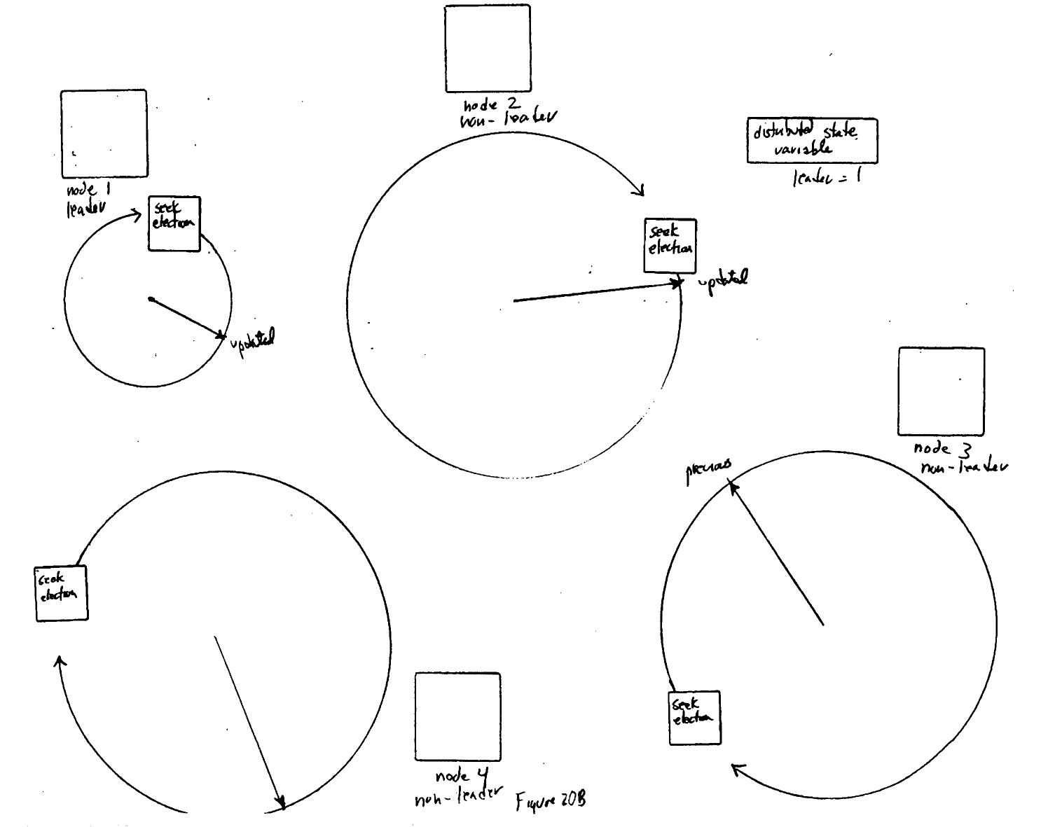

FIG. 19 is a control-flow diagram illustrating an alternative embodiment of the present invention. In step 1902, the routine issues a Paxos or Paxos-like state-change request requesting that the node be designated leader. If the request succeeds, as determined in step 1906, then the node has become the leader for the next lease period, and sets the local delay timer to expire at a fraction LEASE/n of the next lease period in step 1906. The node then sets the fail-stop functionality to expire at the end of the next lease period in step 1908. Otherwise, if the Paxos or Paxos-like request does not succeed, then, in step 1910, the node updates the node's local view of the distributed state variable. Finally, in step 1912, the current node sets the current node's delay timer to the lease period LEASE, in order to again seek election for a next lease period. Otherwise, the current node has acquired leadership, and executes steps 1906 and 1908, as described above. In this embodiment of the present invention, a new leader is elected within a time of (2*LEASE)−LEASE/n.

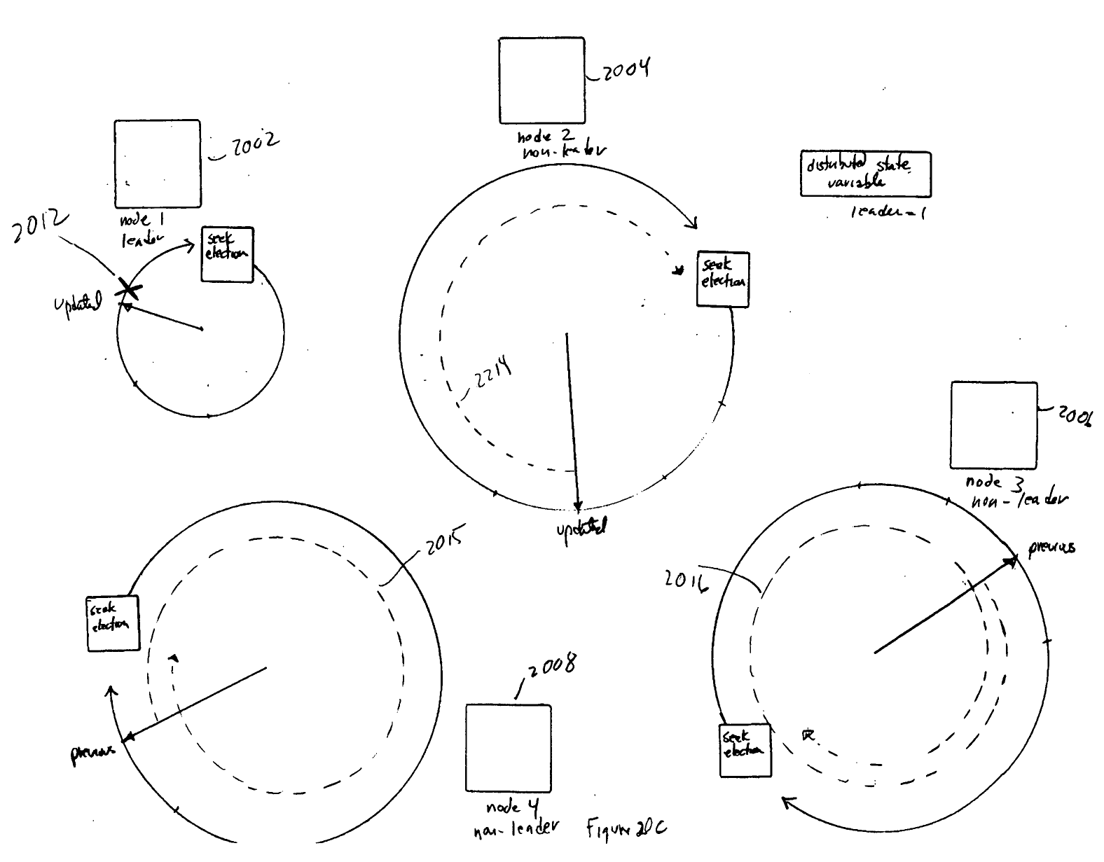

FIGS. 20A-C illustrate operation of the alternative embodiment of the present invention, described above. In FIG. 20A, the current leader node 2002 has just been re-elected, and therefore has a fully updated local view of the distributed state variable. Node 2004 is just about to seek election, but does not have an updated local view of the distributed state variable. Nodes 2006 and 2008 are in different points in their respective election cycles, and do not have an updated local view of the distributed state variable. FIG. 20B shows the four-node system of FIG. 20A following additional lapse of time. The delay timers for all four nodes have advanced, with node 2004 having unsuccessfully sought election, and, as a result, having an updated local view of the distributed state variable. In FIG. 20C, the delay timers have further advanced, and the current leader node 2002 has failed, as indicated by the “X” symbol 2012 in the re-election cycle. As shown in FIG. 20C by dashed lines 2014-2016, the various non-leader nodes need different periods of time to be elected to the leadership role. Node 2004 may become the new leader in the shortest period of time 2014, since node 2004 has an updated local view of the distributed state variable. Nodes 2006 and 2008 both need to first update their local views of the distributed state variable before waiting for a lease period in order to seek election.

Although the present invention has been described in terms of particular embodiments, it is not intended that the invention be limited to these embodiments. Modifications within the spirit of the invention will be apparent to those skilled in the art. For example, strong-leader-election functionality can be implemented in any number of different programming languages, using any number of different modularizations, routines, control structures, variables, data structures, and by varying other such programming parameters. In the described embodiment, the next interval is computed from a global time value. In alternative embodiments, the next interval may simply be a monotonically increasing integer value stored in global state information shared by the nodes of a distributed computer system. A wide variety of different fail-stop functionalities, timer functionalities, and underlying distributed consensus services may be employed to implement strong-leader-election methods according to the present invention. The strong-leader-election methods of the present invention can be incorporated into any number of different types of distributed computer systems, containing arbitrary numbers of nodes, in order to provide for continuous assumption of a leadership role by a node within the distributed computer system. Although the above embodiment discusses a single leadership role, multiple leadership roles may need to be filled in a given distributed computer system, and thus multiple instances of the strong-leader-election method may be employed in order to fill all desired leadership roles according to the present invention. Alternatively, a single multi-leader implementation may use arrays of timers and lease times, and carefully manage the fail-stop functionality, in order to provide for continuous allocation of multiple leader roles. As discussed above, leadership roles may be tied to any of a wide variety of processing tasks, insuring that a single node assumes full or primary responsibility for execution of a given task.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for allocation of a leadership role to a single computer node of a multi-computer-node, distributed computer system, the method comprising:
providing on each node a distributed consensus service through which a node can make state-change requests, timing functionality, fail-stop functionality, and leadership-election functionality; and
contending, by each computer node, for the leadership role for each of successive lease periods by issuing state-change requests through the distributed consensus service so that, when no node is leader, a single node quickly assumes the leadership role and retains the leadership role until the single node surrenders the leadership role or fails.

2. The method of claim 1 wherein the timing functionality is a local delay timer and wherein a computer node contends for the leadership role during handling of a delay-timer expiration by issuing a state-change request for assumption of the leadership role.

3. The method of claim 1 wherein the timing functionality is a leader-election timer synchronized with leader-election timers in other nodes and wherein a computer node contends for the leadership role during handling of a leader-election timer expiration by issuing a state-change request for assumption of the leadership role.

4. The method of claim 3 wherein issuing a state-change request for assumption of the leadership role further includes computing a next-lease-period identifier, and requesting assumption of the leadership role for the next lease period.

5. The method of claim 4 wherein the next-lease-period identifier identifies one of:
the current lease period for a computer node that is not currently allocated the leadership role; and
the lease period following the current lease period for a computer node that is currently allocated the leadership role.

6. The method of claim 3 wherein, following issuing a state-change request for assumption of the leadership role, a computer node resets the timing functionality.

7. The method of claim 6 wherein, when the issued state-change request succeeds, the computer node resets the timing functionality to expire during the next lease period, and additionally resets the fail-safe functionality to signal a failure condition at the end of the next lease period.

8. The method of claim 6 wherein, when the issued state-change request does not succeed, the computer node resets the timing functionality to expire at the end of the next lease period.

9. The method of claim 1 wherein the fail-stop functionality is hardware implemented and generates a hardware reset upon expiration.

10. The method of claim 1 wherein the fail-stop functionality is software implemented, and generates a notification for the leader to discontinue leadership-related processing.

11. A distributed computer system comprising:
a plurality of intercommunicating computer nodes, each computer node having a distributed consensus service through which a node can make state-change request, a timing functionality, and a fail-stop functionality; and
leadership-election functionality within each computer node by which each computer node contends for a leadership role for each of successive lease periods by issuing state-change requests through the distributed consensus service so that, when no node is leader, a single node quickly assumes the leadership role and retains the leadership role until the single node surrenders the leadership role or fails.

12. The distributed computer system of claim 11 wherein the timing functionality is a local delay timer and wherein a computer node contends for the leadership role during handling of a delay-timer expiration by issuing a state-change request for assumption of the leadership role.

13. The distributed computer system of claim 11 wherein the timing functionality is a leader-election timer synchronized with leader-election timers in other nodes and wherein a computer node contends for the leadership role during handling of a leader-election timer expiration by issuing a state-change request for assumption of the leadership role.

14. The distributed computer system of claim 13 wherein issuing a state-change request for assumption of the leadership role further includes computing a next-lease-period identifier, and requesting assumption of the leadership role for the next lease period.

15. The distributed computer system of claim 14 wherein the next-lease-period identifier identifies one of:
the current lease period for a computer node that is not currently allocated the leadership role; and
the lease period following the current lease period for a computer node that is currently allocated the leadership role.

16. The distributed computer system of claim 12 wherein, following issuing a state-change request for assumption of the leadership role, a computer node resets the timing functionality.

17. The distributed computer system of claim 11 wherein, when the issued state-change request succeeds, the computer node resets the timing functionality to expire during the next lease period, and additionally resets the fail-safe functionality to signal a failure condition at the end of the next lease period.

18. The distributed computer system of claim 11 wherein, when the issued state-change request does not succeed, the computer node resets the timing functionality to expire at the end of the next lease period.

19. The method of claim 11 wherein the fail-stop functionality is hardware implemented and generates a hardware reset upon expiration.

20. The method of claim 11 wherein the fail-stop functionality is software implemented, and generates a notification for the leader to discontinue leadership-related processing.
